(19) United States
(12) Patent Application Publication
(10) Pub. No.: US 2007/0035480 A1
(43) Pub. Date: Feb. 15, 2007

(54) Circuit for driving plasma display panel

(75) Inventors: Eiichi Urushibata, Tokyo (JP); Teruo Okamura, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/501,835

(22) Filed: Aug. 10, 2006

(30) Foreign Application Priority Data
Aug. 12, 2005 (JP) 2005-233983

(51) Int. Cl. G09G 3/28

(52) U.S. Cl. 345/68

(57) ABSTRACT

A circuit for driving a plasma display panel includes a scanning-electrode driving circuit for applying a drive voltage to a scanning electrode, which includes a first sustaining-clamp circuit for applying a sustaining-discharge pulse to the scanning electrode, and a reset circuit for applying a reset pulse to the scanning electrode. The first sustaining-clamp circuit includes a first power-source terminal having a voltage higher than a ground voltage. The reset circuit includes a second power-source terminal having a voltage lower than the ground voltage. The first sustaining-clamp circuit includes a first current cut-off device which prevents a current from running to the second power-source terminal from the first ground terminal, positioned in a current path other than a current path through which a current runs when a voltage is applied to the scanning electrode through the first power-source terminal.

### BACKGROUND OF THE INVENTION

1. Field of the Invention

The invention relates to a circuit for driving a plasma display panel.

2. Description of the Related Art

FIG. 1 is a circuit diagram of a conventional circuit 1000 for driving a plasma display panel (PDP).

As illustrated in FIG. 1, the conventional circuit 1000 includes a Y-electrode driving circuit 1100 which applies a drive voltage to a terminal (hereinafter, referred to as “scanning-electrode terminal) of a Y electrode (scanning electrode) in a plasma display panel Cp, and a X-electrode driving circuit 1200 which applies a drive voltage to a terminal (hereinafter, referred to as “common-electrode terminal) of a X electrode (common electrode) in the plasma display panel Cp.

The Y-electrode driving circuit 1100 is comprised of a collection circuit 111, a sustaining-clamp circuit 1102, a reset circuit (priming circuit) 113, a scanning IC 114, and a first coil L1 electrically connected between the collection circuit 111 and the sustaining-clamp circuit 1102.

The collection circuit 111 is comprised of a first capacitor C1, a first transistor switch S1, a second transistor switch S2, a first diode D1, and a second diode D2.

The first capacitor C1 is grounded at one end thereof, and electrically connected at the other end to both a drain terminal of the first transistor S1 and a source terminal of the second transistor switch S2.

The first and second diodes D1 and D2 are electrically connected in series to each other between a source terminal of the first transistor switch S1 and a drain terminal of the second transistor switch S2.

Specifically, a source terminal of the first transistor switch S1 is electrically connected to an anode terminal of the first diode D1, a cathode terminal of the first diode D1 is electrically connected to an anode terminal of the second diode D2, and a cathode terminal of the second diode D2 is electrically connected to a drain terminal of the second transistor switch S2.

The sustaining-clamp circuit 1102 includes third to sixth transistor switches S3 to S6.

The third transistor switch S3 has a drain terminal electrically connected to a power-source terminal VS, and a source terminal electrically connected to both a drain terminal of the fifth transistor switch S5 and a drain terminal of the fourth transistor switch S4.

The fourth transistor switch S4 has a source terminal electrically connected to a ground terminal G1.

The fifth transistor switch S5 has a source terminal electrically connected to a source terminal of the sixth transistor switch S6.

The first coil L1 is electrically connected at one end thereof to a second junction J2 at which the third to fifth transistor switches S3, S4 and S5 are electrically connected to one another, and at the other end thereof to a first junction J1 at which the first and second diodes D1 and D2 are electrically connected to each other.

The reset circuit 113 is comprised of a seventh transistor switch S7 and an eighth transistor switch S8.

The seventh transistor switch S7 has a drain terminal electrically connected to a power-source terminal VP, and a source terminal electrically connected to a drain terminal of the eighth transistor switch S8.

The eighth transistor switch S8 has a source terminal electrically connected to a power-source terminal VW.

The sixth transistor switch S6 has a drain terminal electrically connected to a third junction J3 at which a source terminal of the seventh transistor switch S7 and a drain terminal of the eighth transistor switch S8 are electrically connected to each other.

The scanning IC 114 is comprised of a sixteenth transistor switch S21, a seventeenth transistor switch S22, a seventh diode D10, an eighth diode D11, a first inverter I22, and a second inverter I22.

The sixteenth transistor switch S21 has a drain terminal electrically connected to both a power-source terminal VH and a cathode terminal of the seventh diode D10, and a source terminal electrically connected to a drain terminal of the seventeenth transistor switch S22.

The seventeenth transistor switch S22 has a source terminal electrically connected to the above-mentioned third junction J3 and an anode terminal of the eighth diode D11.

The eighth diode D11 has a cathode terminal electrically connected to both an anode terminal of the seventh diode D10 and a sixth junction J6 at which a source terminal of the sixteenth transistor switch S21 and a drain terminal of the seventeenth transistor switch S22 are electrically connected to each other.

The first inverter I22 has an output terminal electrically connected to both a gate terminal of the sixteenth transistor switch S21 and an input terminal of the second inverter I22.

The second inverter I22 has an output terminal electrically connected to both a gate terminal of the seventeenth transistor switch S22 and an input terminal of the first inverter I22.

A fifth junction J5 at which the fifth and sixth diodes D10 and D11 are electrically connected to each other is electrically connected to the scanning-electrode terminal of the plasma display panel Cp.

The X-electrode driving circuit 1200 is comprised of a collection circuit 121, a sustaining-clamp circuit 1202, a sub-voltage applying circuit 123, a reset-enhancing circuit 124, and a second coil L1.

The sub-voltage applying circuit 123 includes a ninth transistor switch S9 having a drain terminal electrically connected to a power-source terminal VSW.

The reset-enhancing circuit 124 includes a tenth transistor switch S10 having a source terminal electrically connected to a power-source terminal VRST, and a drain terminal electrically connected to a source terminal of the ninth transistor switch S9.

A ninth junction J9 at which a source terminal of the ninth transistor switch S9 and a drain terminal of the tenth transistor switch S10 are electrically connected to each other is electrically connected to the common-electrode terminal of the plasma display panel Cp.

The sustaining-clamp circuit 1202 includes eleventh to thirteenth transistor switches S11 to S13.

The eleventh transistor switch S11 has a source terminal electrically connected to the common-electrode terminal of the plasma display panel Cp through the ninth junction J9, and a drain terminal electrically connected to both a source terminal of the twelfth transistor switch S12 and a drain terminal of the thirteenth transistor switch S13.

The thirteenth transistor switch S13 has a source terminal electrically connected to a ground terminal G2.

The twelfth transistor switch S12 has a drain terminal electrically connected to a power-source terminal VS.

The collection circuit 121 includes a fourteenth transistor switch S14, a fifteenth transistor switch S15, a third diode D3, a fourth diode D4, and a second capacitor C2.

The second capacitor C2 is grounded at one end thereof, and is electrically connected at the other end thereof to both a drain terminal of the fourteenth transistor switch S14 and a source terminal of the fifteenth transistor switch S15.

The third and fourth diodes D3 and D4 are electrically connected in series to each other between a source terminal of the fourteenth transistor switch S14 and a drain terminal of the fifteenth transistor switch S15.

Specifically, a source terminal of the fourteenth transistor switch S14 is electrically connected to an anode terminal of the third diode D3, a cathode terminal of the third diode D3 is electrically connected to an anode terminal of the fourth diode D4, and a cathode terminal of the fourth diode D4 is electrically connected to a drain terminal of the fifteenth transistor switch S15.

The second coil L1 is electrically connected at one end thereof to a seventh junction J7 at which the third and fourth diodes D3 and D4 are electrically connected to each other, and at the other end thereof to an eighth junction J8 at which the eleventh, twelfth and thirteenth transistor switches S11, S12 and S13 are electrically connected to one another.

A voltage applied to the power-source terminal VP is higher than a voltage applied to the power-source terminal VS.

A voltage applied to the power-source terminal VSW is higher than a voltage applied to the power-source terminal VS.

The voltages applied to the power-source terminals VS, VP and VSW are higher than a voltage of the first and second ground terminals G1 and G2.

In contrast, the voltages applied to the power-source terminals VW and VRST are lower than a voltage of the first and second ground terminals G1 and G2.

A voltage applied to the power-source terminal VH is higher than a voltage applied to the scanning-electrode terminal of the plasma display panel Cp by α except a scanning period (see FIG. 2).

Control signals are input into each of gate terminals of the first to fifteenth transistor switches S1 to S15 and each of input terminals of the first and second inverters I22 and I22 of the scanning IC 114. On/off control is made to the first to seventeenth transistor switches S1 to S15, S21 and S22 in accordance with the controls signals.

FIG. 2 is a timing chart showing an operation of the PDP driving circuit 1000.

FIG. 2 illustrates waveforms of control signals to be input into gate terminals of the first to fifteenth transistor switches S1 to S15, a waveform of a voltage to be applied to a scanning electrode of the plasma display panel Cp (Y-electrode waveform), a waveform of a voltage to be applied to a common electrode of the plasma display panel Cp (X-electrode waveform), a waveform of a voltage to be input into the power-source terminal VH (VH waveform), and a waveform of a voltage found at the third junction J3 (J3 waveform).

The PDP driving circuit 1000 repeatedly carries out an operation including a first reset period, a second reset period, a scanning period, and a sustaining period, as illustrated in FIG. 2, in accordance with the control signals input into gate terminals of the first to fifteenth transistor switches S1 to S15 and the control signals input into input terminals of the first and second inverters I22 and I22.

In the first and second reset periods, wall charges remaining even after the sustaining period are reduced or eliminated. In the scanning period, data-writing discharge is generated to select a cell to be turned on. In the sustaining period, sustaining discharge is generated in the cell having been selected in the scanning period to thereby emit a light from the selected cell.

As illustrated in FIG. 2, at first in the first reset period, the transistor switches S1, S2, S3, S7, S8, S9, S10, S12, S14 and S15 are turned off, whereas the transistor switches S4, S5, S6, S11 and S13 are turned on.

The sixteenth transistor switch S21 in the scanning IC 114 is turned off, whereas the seventeenth transistor switch S22 is turned on.

Accordingly, a voltage which is applied to the scanning-electrode terminal of the plasma display panel Cp by the Y-electrode driving circuit 1100 is equal to a voltage of the ground terminal G1, and a voltage which is applied to the common-electrode terminal of the plasma display panel Cp by the X-electrode driving circuit 1200 is equal to a voltage, of the ground terminal G2.

The waveform of the power-source terminal VH is higher than the Y-electrode waveform by α. The waveform at the third junction J3 is higher han the Y-electrode waveform by a except the scanning period.

At a timing T1 in the first reset period, the first and tenth transistor witches S1 and S10 are turned on, whereas the fourth, eleventh and thirteenth ransistor switches S4, S11 and S13 are turned off.

Thus, in the Y-electrode driving circuit 1100, a current i1 runs to the scanning-electrode terminal of the plasma display panel Cp from the first capacitor C1 of the collection circuit 111 through the first transistor switch S1, the first diode D1, the first junction J1, the first coil L1, the second junction J2, the fifth transistor switch S5, the sixth transistor switch S6, the third junction J3, a fourth junction J4 (a junction at which the seventeenth transistor switch S22 and the third junction J3 are electrically connected to each other), the eighth diode D11, and the fifth junction J5 in this order.

In the X-electrode driving circuit 1200, a current i2 runs to the power-source terminal VRST from the common-electrode terminal of the plasma display panel Cp through the ninth junction J9 and the tenth transistor switch S10.

As a result, a voltage applied by the Y-electrode driving circuit 1100 to the scanning electrode of the plasma display panel Cp increases to a voltage of the power-source terminal VS from a voltage of the ground terminal G1, and a voltage applied by the X-electrode driving circuit 1200 to the common electrode of the plasma display panel Cp decreases to a voltage of the power-source terminal VRST from a voltage of the ground terminal G2.

At a timing T2 in the first reset period, the first, fifth and sixth transistor switches S1, S5 and S6 are turned off, whereas the third and seventh transistor switches S3 and S7 are turned on.

As a result, in the Y-electrode driving circuit 1100, a current i3 runs to the scanning-electrode terminal of the plasma display panel Cp from the power-source terminal VP of the reset circuit 113 through the seventh transistor switch S7, the third junction J3, the fourth junction J4, the eighth diode D11 and the fifth junction J5 in this order.

Accordingly, a voltage applied by the Y-electrode driving circuit 1100 to the scanning electrode of the plasma display panel Cp increases to a voltage of the power-source voltage VP from a voltage of the power-source terminal VS, and a voltage applied by the X-electrode driving circuit 1200 to the common electrode of the plasma display panel Cp is kept equal to a voltage of the power-source terminal VRST.

At a timing T3 in the first reset period, the second, fifth and sixth transistor switches S2, S5 and S6 are turned on, whereas the third and seventh transistor switches S3 and S7 are turned off.

As a result, in the Y-electrode driving circuit 1100, a current i4 runs to the first capacitor C1 of the collection circuit 111 from the scanning-electrode terminal of the plasma display panel Cp through the fifth junction J5, the sixth junction J6, the seventeenth transistor switch S22, the fourth junction J4, the third junction J3, the sixth transistor switch S6, the fifth transistor switch S5, the second junction J2, the first coil L1, the first junction J1 and the second transistor switch S2 in this order.

Accordingly, a voltage applied by the Y-electrode driving circuit 1100 to the scanning electrode of the plasma display panel Cp steeply decreases to a voltage of the power-source terminal VS from a voltage of the power-source terminal VP, and then, gradually decreases from a voltage of the power-source terminal VS.

At a timing T4 in the first reset period, the eleventh and thirteenth transistor switches S11 and S13 are turned on, whereas the tenth transistor switch S10 is turned off.

As a result, in the X-electrode driving circuit 1200, a current i5 runs to the scanning-electrode terminal of the plasma display panel Cp from the ground erminal G2 through the thirteenth transistor switch S13, the eighth junction J8, the eleventh transistor switch S11 and the ninth junction J9 in this order.

Accordingly, a voltage applied by the X-electrode driving circuit 1200 to the common electrode of the plasma display panel Cp gradually increases to a ground voltage from a voltage of the power-source terminal VRST.

At a timing T5 in the first reset period, the fourth transistor switch S4 is turned on, whereas the second transistor switch S2 is turned off.

As a result, in the Y-electrode driving circuit 1100, a current i6 runs to the ground terminal G1 from the scanning-electrode terminal of the plasma display panel Cp through the fifth junction J5, the sixth junction J6, the seventeenth transistor switch S22, the fourth junction J4, the third junction J3, the sixth transistor switch S6, the fifth transistor switch S5, the second junction J2, the fifth transistor switch S5, and the fourth transistor switch S4 in this order.

Accordingly, a voltage applied by the Y-electrode driving circuit 1100 to the scanning electrode of the plasma display panel Cp steeply decreases to a voltage of the ground terminal G1.

The first reset period is defined as a period in which a voltage applied by the X-electrode driving circuit 1200 to the common electrode of the plasma display panel Cp increases to a voltage of the ground terminal G2.

At a timing T6 in the second reset period, the thirteenth transistor switch S13 is turned off, whereas the fourteenth transistor switch S14 is turned on.

As a result, in the X-electrode driving circuit 1200, a current i7 runs to the common-electrode terminal of the plasma display panel Cp from the second capacitor C2 through the fourteenth transistor switch S14, the seventh junction J7, the second coil L2, the eighth junction J8, the eleventh transistor switch S11, and the ninth junction J9 in this order.

Accordingly, a voltage applied. by the X-electrode driving circuit 1200 to the common electrode of the plasma display panel Cp gradually increases from a voltage of the ground terminal G2.

At a timing T7 in the second reset period, the twelfth transistor switch S12 is turned on, whereas the fourteenth transistor switch S14 is turned off.

As a result, in the X-electrode driving circuit 1200, a current i8 runs to the common-electrode terminal of the plasma display panel Cp from the power-source terminal VS through the twelfth transistor switch S12, the eighth junction J8, the eleventh transistor switch S11, and the ninth junction J9 in this order.

Accordingly, a voltage applied by the X-electrode driving circuit 1200 to the common electrode of the plasma display panel Cp steeply increases to a voltage of the power-source terminal VS.

At a timing T8 in the second reset period, the twelfth transistor switch S12 is turned off, whereas the fifteenth transistor switch S15 is turned on.

As a result, in the X-electrode driving circuit 1200, a current i9 runs to the second capacitor C2 from the common-electrode terminal of the plasma display panel Cp through the ninth junction J9, the eleventh transistor switch S11, the eighth junction J8, the second coil L2, the seventh junction J7, the fourth diode D4, and the fifteenth transistor switch S15 in this order.

Accordingly, a voltage applied by the X-electrode driving circuit 1200 to the common electrode of the plasma display panel Cp gradually decreased from a voltage of the power-source terminal VS.

At a timing T9 in the second reset period, the thirteenth transistor switch S13 is turned on, whereas the fifteenth transistor switch S15 is turned off.

As a result, in the X-electrode driving circuit 1200, a current ilO runs to the ground terminal G2 from the common-electrode terminal of the plasma display panel Cp through the ninth junction J9, the eleventh transistor switch S11, the eighth junction J8, and the thirteenth transistor switch S13 in this order.

Accordingly, a voltage applied by the X-electrode driving circuit 1200 to he common electrode of the plasma display panel Cp steeply decreases to a voltage of the ground terminal G2.

At a timing T10 in the second reset period, the first transistor switch S1 is turned on, whereas the fourth transistor switch S4 is turned off.

As a result, in the Y-electrode driving circuit 1100, a current i11 runs to the scanning-electrode terminal of the plasma display panel Cp from the first capacitor C1 through the first transistor switch S1, the first diode D1, the first junction J1, the first coil L1, the second junction J2, the fifth transistor switch S5, the sixth transistor switch S6, the third junction J3, the fourth junction J4, the eighth diode D11, and the fifth junction J5 in this order.

Accordingly, a voltage applied by the Y-electrode driving circuit 1100 to the scanning electrode of the plasma display panel Cp gradually increases.

At a timing T11 in the second reset period, the first transistor switch S1 is turned off, whereas the third transistor switch S3 is turned on.

As a result, in the Y-electrode driving circuit 1100, a current ill runs to the scanning-electrode terminal of the plasma display panel Cp from the power-source terminal VS through the third transistor switch S3, the second junction J2, the fifth transistor switch S5, the sixth transistor switch S6, the third junction J3, the fourth junction J4, the eighth diode D11, and the fifth junction J5 in this order.

Accordingly, a voltage applied by the Y-electrode driving circuit 1100 to the scanning electrode of the plasma display panel C steeply increases to a voltage of the power-source terminal VS.

At a timing T12 in the second reset period, the second transistor switch S2 is turned on, whereas the third transistor switch S3 is turned off.

As a result, in the Y-electrode driving circuit 1100, a current i4 runs to the first capacitor C1 from the scanning electrode of the plasma display panel Cp through the fifth junction J5, the sixth junction J6, the seventeenth transistor witch S22, the fourth junction J4, the third junction J3, the sixth transistor witch S6, the fifth transistor switch S5, the second junction J2, the first coil L1, the first junction J1, and the second transistor switch S2 in this order.

Accordingly, a voltage applied by the Y-electrode driving circuit 1100 to the scanning electrode of the plasma display panel C gradually decreases from a voltage of the power-source terminal VS.

At a timing T13 at which the scanning period starts, the second and thirteenth transistor switches S2 and S13 are turned off, whereas the fourth and ninth transistor switches S4 and S9 are turned on.

As a result, in the Y-electrode driving circuit 1100, a current i6 runs to the ground terminal G1 from the scanning electrode of the plasma display panel Cp through the fifth junction J5, the sixth junction J6, the seventeenth transistor switch S22, the fourth junction J4, the third junction J3, the sixth transistor switch S6, the fifth transistor switch S5, the second junction J2, and the fourth transistor switch S4 in this order.

Further, in the X-electrode driving circuit 1200, a current i12 runs to the common-electrode terminal of the plasma display panel Cp from the power-source terminal VSW through the ninth transistor switch S9 and the ninth junction J9 in this order.

Accordingly, a voltage applied by the Y-electrode driving circuit 1100 to the scanning electrode of the plasma display panel Cp steeply decreases to a voltage of the ground terminal G1, and a voltage applied by the X-electrode driving circuit 1200 to the common electrode of the plasma display panel Cp gradually increases to a voltage of the power-source terminal VSW.

At a timing T14 in the scanning period, the fourth, fifth and sixth transistor switches S4, S5 and S6 are turned off, whereas the eighth transistor switch S8 is turned on.

Further, at the timing T14, the sixteenth transistor switch S21 is turned on, whereas the seventeenth transistor switch S22 is turned off.

As a result, in the Y-electrode driving circuit 1100, a current runs to the scanning electrode of the plasma display panel Cp from the power-source terminal VH through the sixteenth transistor switch S21, the sixth junction J6, and the fifth junction J5 in this order.

Accordingly, a voltage applied by the Y-electrode driving circuit 1100 to the scanning electrode of the plasma display panel Cp gradually increases from a voltage of the ground terminal G1.

A voltage of the power-source terminal VH gradually increases from a sum of a ground voltage and α.

Further, a voltage of the third junction J3 gradually decreases to a sum of a voltage of the power-source terminal VW and α from a sum of a ground voltage and α.

In a line selected in the scanning period, after a timing TS1 at which the sixteenth transistor switch S21 was turned off and the seventeenth transistor switch S22 was turned on, the sixteenth transistor switch S21 is turned on and the seventeenth transistor switch S22 is turned off at a timing TS2.

As a result, during the timing TS1 and the timing TS2 in the Y-electrode driving circuit 1100, a current i13 runs to the power-source terminal VW from the scanning electrode of the plasma display panel Cp through the fifth junction J5, the sixth junction J6, the seventeenth transistor switch S22, the fourth junction J4, the third junction J3, and the eighth transistor switch S8 in this order.

Accordingly, a voltage applied by the Y-electrode driving circuit 1100 to the scanning electrode of the plasma display panel Cp steeply decreases to a voltage of the power-source terminal VW.

At the timing TS2, a current runs to the scanning electrode of the plasma display panel Cp from the power-source terminal VH through the sixteenth transistor switch S21, the sixth junction J6, and the fifth junction J5 in this order.

Accordingly, a voltage applied by the Y-electrode driving circuit 1100 to he scanning electrode of the plasma display panel Cp steeply increases from a oltage of the power-source terminal VW.

The above-mentioned selection (that is, data-writing) is carried out to every selected line in order.

At a timing T15 in the scanning period, the ninth transistor switch S9 is turned off, whereas the fifteenth transistor switch S15 is turned on.

As a result, in the X-electrode driving circuit 1200, a current i9 runs to the second capacitor C2 from the common electrode of the plasma display panel Cp through the ninth junction J9, the eleventh transistor switch S11, the eighth junction J8, the second coil L2, the fourth diode D4, and the fifteenth transistor switch S15 in this order.

Accordingly, a voltage applied by the X-electrode driving circuit 1200 to the common electrode of the plasma display panel Cp gradually decreases from a voltage of the power-source terminal VSW.

At a timing T16 in the scanning period, the fourth, fifth and sixth transistor switches S4, S5 and S6 are turned on, whereas the eighth transistor switch S8 is turned off.

Further, at the timing T16, the sixteenth transistor switch S21 is turned off, whereas the seventeenth transistor switch S22 is turned on.

As a result, in the Y-electrode driving circuit 1100, a current i6 runs to the ground terminal G1 from the scanning electrode of the plasma display panel Cp through the fifth junction J5, the sixth junction J6, the seventeenth transistor switch S22, the fourth junction J4, the third junction J3, the sixth transistor switch S6, the fifth transistor switch S5, and the fourth transistor switch S4 in this order.

Accordingly, a voltage applied by the Y-electrode driving circuit 1100 to the scanning electrode of the plasma display panel Cp gradually decreases to a voltage of the ground terminal G1.

A voltage of the power-source terminal VH gradually decreases to a sum of a ground voltage and α, and a voltage of the third junction J3 gradually increases to a sum of a ground voltage and α.

At a timing T17 at which the sustaining period starts, the thirteenth transistor switch S13 is turned on, whereas the fifteenth transistor switch S15 is turned off.

As a result, in the X-electrode driving circuit 1200, a current i10 runs to the ground terminal G2 from the common electrode of the plasma display panel Cp through the ninth junction J9, the eleventh transistor switch S11, the eighth junction J8, and the thirteenth transistor switch S13 in this order.

Accordingly, a voltage applied by the X-electrode driving circuit 1200 to the common electrode of the plasma display panel Cp steeply decreases to a voltage of the ground terminal G2.

At a timing T18 in the sustaining period, the first transistor switch S1 is turned on, whereas the fourth transistor switch S4 is turned off.

As a result, in the Y-electrode driving circuit 1100, a current i1 runs to the scanning electrode of the plasma display panel Cp from the first capacitor C1 through the first transistor switch S1, the first diode D1, the first junction J1, the first coil L1, the second junction J2, the fifth transistor switch S5, the sixth transistor switch S6, the third junction J3, the fourth junction J4, the eighth diode D11, and the fifth junction J5 in this order.

Accordingly, a voltage applied by the Y-electrode driving circuit 1100 to the scanning electrode of the plasma display panel Cp gradually increases from a voltage of the ground terminal G1.

At a timing T20 in the sustaining period, the first transistor switch S1 is turned off, whereas the third transistor switch S3 is turned on.

As a result, in the Y-electrode driving circuit 1100, a current i11 runs to the scanning-electrode terminal of the plasma display panel Cp from the power-source terminal VS through the third transistor switch S3, the second junction J2, the fifth transistor switch S5, the sixth transistor switch S6, the hird junction J3, the fourth junction J4, the eighth diode D11, and the fifth function J5 this order.

Accordingly, a voltage applied by the Y-electrode driving circuit 1100 to the scanning electrode of the plasma display panel Cp steeply increases to a voltage of the power-source terminal VS.

At a timing T21 in the sustaining period, the second transistor switch S2 is turned on, whereas the third transistor switch S3 is turned off.

As a result, in the Y-electrode driving circuit 1100, a current i4 runs to the first capacitor C1 from the scanning electrode of the plasma display panel Cp through the fifth junction J5, the sixth junction J6, the fifth transistor switch S5, the seventeenth transistor switch S22, the fourth junction J4, the third junction J3, the sixth transistor switch S6, the second junction J2, the first coil L1, the first junction J1, and the second transistor switch S2 in this order.

Accordingly, a voltage applied by the Y-electrode driving circuit 1100 to the scanning electrode of the plasma display panel Cp gradually decreases from a voltage of the power-source terminal VS.

At a timing T22 in the sustaining period, the second transistor switch S2 is turned off, whereas the fourth transistor switch S4 is turned on.

As a result, in the Y-electrode driving circuit 1100, a current i6 runs to the ground terminal G1 from the scanning electrode of the plasma display panel Cp through the fifth junction J5, the sixth junction J6, the seventeenth transistor switch S22, the fourth junction J4, the third junction J3, the sixth transistor switch S6, the fifth transistor switch S5, the second junction J2, and the fourth transistor switch S4 in this order.

Accordingly, a voltage applied by the Y-electrode driving circuit 1100 to the scanning electrode of the plasma display panel Cp steeply decreases to a voltage of the ground terminal G1.

At a timing T23 in the sustaining period, the thirteenth transistor switch S13 is turned off, whereas the fourteenth transistor switch S14 is turned on.

As a result, in the X-electrode driving circuit 1200, a current i7 runs to the common-electrode terminal of the plasma display panel Cp from the second capacitor C2 through the fourteenth transistor switch S14, the seventh junction J7, the second coil L2, the eighth junction J8, the eleventh transistor switch S11, and the ninth junction J9 in this order.

Accordingly, a voltage applied by the X-electrode driving circuit 1200 to the common electrode of the plasma display panel Cp gradually increases from a voltage of the ground terminal G2.

At a timing T24 in the sustaining period, the twelfth transistor switch S12 is turned on, whereas the fourteenth transistor switch S14 is turned off.

As a result, in the X-electrode driving circuit 1200, a current i8 runs to the common-electrode terminal of the plasma display panel Cp from the power-source terminal VS through the twelfth transistor switch S12, the eighth junction J8, the eleventh transistor switch S11, and the ninth junction J9 in this order.

Accordingly, a voltage applied by the X-electrode driving circuit 1200 to the common electrode of the plasma display panel Cp steeply increases to a voltage of the power-source terminal VS.

At a timing T25 in the sustaining period, the twelfth transistor switch S12 is turned off, whereas the fourteenth transistor switch S14 is turned on.

As a result, in the X-electrode driving circuit 1200, a current i9 runs to the second capacitor C2 from the common-electrode terminal of the plasma display panel Cp through the ninth junction J9, the eleventh transistor switch S11, the eighth junction J8, the second coil L2, the seventh junction J7, the fourth diode D4, and the fifteenth transistor switch S15 in this order.

Accordingly, a voltage applied by the X-electrode driving circuit 1200 to the common electrode of the plasma display panel Cp gradually decreases from a voltage of the power-source terminal VS.

At a timing T26 in the sustaining period, the thirteenth transistor switch S13 is turned on, whereas the fifteenth transistor switch S15 is turned off.

As a result, in the X-electrode driving circuit 1200, a current i10 runs to the ground terminal G2 from the common-electrode terminal of the plasma display panel Cp through the ninth junction J9, the eleventh transistor switch S11, the eighth junction J8, and the thirteenth transistor switch S13 in this order.

Accordingly, a voltage applied by the X-electrode driving circuit 1200 to the common electrode of the plasma display panel Cp steeply decreases to a voltage of the ground terminal G2.

Hereinafter, the operations carried out at the timings T18 to T26 are repeatedly carried out by the number of sustaining-discharge pulses, and then, the operation in the first reset period restarts.

Among the parts constituting the PDP driving circuit 1000, the sixth transistor switch S6 acts as a cut switch for preventing a current from running into the power-source terminal VS from the power-source terminal VP having a voltage higher than a voltage of the power-source terminal VS.

Similarly, the fifth transistor switch S5 acts as a cut switch for preventing a current from running into the power-source terminal VW having a negative voltage from the ground terminal G1.

Similarly, the eleventh transistor switch S11 acts as a cut switch for preventing a current from running into the power-source terminal VRST having a negative voltage from the ground terminal G2.

FIG. 3 is a circuit diagram of a circuit 2000 for driving a plasma display panel, suggested in Japanese Patent Application Publication No. 2003-76323.

As illustrated in FIG. 3, the circuit 2000 is comprised of a circuit 2100 for driving a Y-electrode, and a circuit 2200 for driving a X-electrode.

The Y-electrode driving circuit 2100 includes a voltage-collecting circuit 10, a reset-pulse transmitting circuit 20, a scan-buffer IC 30, and a scan-pulse transmitting circuit 40.

The reset-pulse transmitting circuit 20 includes a power source Vset providing a high voltage for applying a reset-pulse to a scanning electrode of a plasma display panel Cp, and a diode Ds which prevents a current derived from the power source Vset from entering the voltage-collecting circuit 10.

A current derived from the power source Vset runs into the scan-pulse transmitting circuit 40 through the scan-buffer IC 30. Hence, the scan-pulse transmitting circuit 40 includes a transistor switch Ysp for preventing the current from running into the voltage-collecting circuit 10.

Since a plasma display panel Cp is a capacitive load, a voltage for driving a plasma display panel Cp is relatively high, specifically, in the range of tens to hundreds of volts.

Accordingly, there is caused much power loss when a current caused when a drive voltage is applied to a plasma display panel Cp runs through parts constituting the circuit which drives the plasma display panel Cp.

In particular, since a sustaining-discharge pulse is applied a lot of times to the driving circuit, it is necessary to reduce the power loss caused when a sustaining-discharge pulse is applied to the driving circuit.

In the conventional circuit 1000 illustrated in FIG. 1, a sustaining-discharge pulse which causes a plasma display panel Cp to emit a light is generated by switching operation carried out by the first to fourth transistor switches S1 to S4 in the Y-electrode driving circuit 1100, and by switching operation carried out by the twelfth to fifteenth transistor switches S12 to S15 in the X-electrode driving circuit 1200.

Due to the switching operations carried out by the first to fourth transistor switches S1 to S4 and the twelfth to fifteenth transistor switches S12 to S15, currents i1, i4, i11, i6, i8, i10, i7 and i9 run through the transistor switches S1 to S4 and S12 to S15, respectively.

Accordingly, when a sustaining-discharge pulse is applied to the onventional circuit 1000 illustrated in FIG. 1, the currents i1, i4, i11 and i6 run through the fifth and sixth transistor switches S5 and S6 both acting as a cut switch, and the currents i8, i10, i7 and i9 run through the eleventh transistor switch S11 acting as a cut switch, resulting in much power loss.

The conventional circuit 2000 illustrated in FIG. 3 is similarly accompanied with a problem that there is caused power loss in both the diode Ds and the transistor switch Ysp, when a sustaining-discharge pulse is applied to the circuit 2000.

### SUMMARY OF THE INVENTION

It is an object of the present invention to solve the above-mentioned problems in the prior art.

In one aspect of the present invention, there is provided a circuit for driving a plasma display panel, including a scanning-electrode driving circuit for applying a drive voltage to a scanning electrode in the plasma display panel, the scanning-electrode driving circuit including a first sustaining-clamp circuit for applying a sustaining-discharge pulse to the scanning electrode, and a reset circuit for applying a reset pulse to the scanning electrode, the first sustaining-clamp circuit including a first power-source terminal having a voltage higher than a ground voltage, a first switching device through which the first power-source terminal can be electrically connected to the scanning electrode, a first ground terminal having a ground voltage, and a second switching device through which the first ground terminal can be electrically connected to the scanning electrode, the reset circuit including a second power-source terminal having a voltage lower than the ground voltage, and a third switching device through which the second power-source terminal can be electrically connected to the scanning electrode, the first sustaining-clamp circuit including a first current cut-off device which prevents a current from running to the second power-source terminal from the first ground terminal, the first current cut-off device being positioned in the first sustaining-clamp circuit in a current path other than a current path through which a current runs when a voltage is applied to the scanning electrode through the first power-source terminal.

In the circuit in accordance with the present invention, since the first current cut-off device is positioned in the first sustaining-clamp circuit in a current path other than a current path through which a current runs when a voltage is applied to the scanning electrode through the first power-source terminal, it is possible to reduce power loss caused by a current running through the first current cut-off device.

For instance, the first current cut-off device may comprise a switching device or a diode.

It a preferable embodiment, the scanning-electrode driving circuit further includes a first collection circuit which applies a voltage to the scanning electrode and collects a voltage from the scanning electrode, wherein the first current cut-off device is positioned in the first sustaining-clamp circuit in a current path other than a current path through which a current runs when the first collection circuit applies a voltage to the scanning electrode, or when the first collection circuit collects a voltage from the scanning electrode.

This embodiment makes it possible to further reduce power loss caused by a current running through the first current cut-off device.

It a preferable embodiment, the reset circuit includes a third power-source terminal having a voltage higher than a voltage of the first power-source terminal, and a fourth switching device through which the third power-source terminal can be electrically connected to the scanning electrode, the first sustaining-clamp circuit including a second current cut-off device which prevents a current from running to the first power-source terminal from the third power-source terminal, the second current cut-off device being positioned in the first sustaining-clamp circuit in a current path other than a current path through which a current runs when the scanning electrode is electrically connected to the first power-source terminal.

This embodiment makes it possible to reduce power loss caused by a current running through the second current cut-off device.

It a preferable embodiment, the reset circuit includes a third power-source terminal having a voltage higher than a voltage of the first power-source terminal, and a fourth switching device through which the third power-source terminal can be electrically connected to the scanning electrode, the first sustaining-clamp circuit including a second current cut-off device which prevents a current from running to the first power-source terminal from the third power-source terminal, the second current cut-off device being positioned in the first sustaining-clamp circuit in a current path other than a current path through which a current runs when the first collection circuit applies a voltage to the scanning electrode, when the first collection circuit collects a voltage from the scanning electrode, or when the scanning electrode is electrically connected to the first power-source terminal.

This embodiment makes it possible to further reduce power loss caused by a current running through the first current cut-off device, and further, to reduce power loss caused by a current running through the second current cut-off device.

For instance, the second current cut-off device may comprise a switching device or a diode.

There is further provided a circuit for driving a plasma display panel, including a scanning-electrode driving circuit for applying a drive voltage to a scanning electrode in the plasma display panel, the scanning-electrode driving circuit including a first sustaining-clamp circuit for applying a sustaining-discharge pulse to the scanning electrode, and a reset circuit for applying a reset pulse to the scanning electrode, the first sustaining-clamp circuit including a first power-source terminal, a first switching device through which the first power-source terminal can be electrically connected to the scanning electrode, and a first ground terminal having a ground voltage, the reset circuit including a third power-source terminal having a voltage higher than a voltage of the first power-source terminal, and a fourth switching device through which the third power-source terminal can be electrically connected to the scanning electrode, the first sustaining-clamp circuit including a second current cut-off device which prevents a current from running to the first power-source terminal from the third power-source terminal, the second current cut-off device being positioned in the first sustaining-clamp circuit in a current path other than a current path through which a current runs when the scanning electrode is electrically connected to the first ground terminal.

In the circuit in accordance with the present invention, since the second current cut-off device is positioned in the first sustaining-clamp circuit in a current path other than a current path through which a current runs when the scanning electrode is electrically connected to the first ground terminal, it is possible to reduce power loss caused by a current running through the second current cut-off device.

It a preferable embodiment, the scanning-electrode driving circuit further includes a first collection circuit which applies a voltage to the scanning electrode and collects a voltage from the scanning electrode, wherein the second current cut-off device is positioned in the first sustaining-clamp circuit in a current path other than a current path through which a current runs when the first collection circuit applies a voltage to the scanning electrode, or when the first collection circuit collects a voltage from the scanning electrode.

This embodiment ensures it possible to further reduce power loss caused by a current running through the second current cut-off device.

There is still further provided a circuit for driving a plasma display panel, including a common-electrode driving circuit for applying a drive voltage to a common electrode in the plasma display panel, the common-electrode driving circuit including a second sustaining-clamp circuit for applying a sustaining-discharge pulse to the common electrode, and a reset-enhancing circuit which applies a pulse to the common electrode for enhancing resetting performance of the common electrode, the second sustaining-clamp circuit including a fourth power-source terminal having a voltage higher than a ground voltage, a fifth switching device through which the fourth power-source terminal can be electrically connected to the common electrode, a second ground terminal having a ground voltage, and a sixth switching device through which the second ground terminal can be electrically connected to the common electrode, the reset-enhancing circuit including a fifth power-source terminal having a voltage lower than a ground voltage, and a seventh switching device through which the fifth power-source terminal can be electrically connected to the common electrode, the second sustaining-clamp circuit including a third current cut-off device which prevents a current from running to the fifth power-source terminal from the second ground terminal, the third current cut-off device being positioned in the second sustaining-clamp circuit in a current path other than a current path through which a current runs -when a voltage is applied to the common electrode through the fourth power-source terminal.

In the circuit in accordance with the present invention, since the third current cut-off device is positioned in the second sustaining-clamp circuit in a current path other than a current path through which a current runs when a voltage is applied to the common electrode through the fourth power-source terminal, it is possible to reduce power loss caused by a current running through the third current cut-off device.

There is yet further provided a circuit for driving a plasma display panel, including a common-electrode driving circuit for applying a drive voltage to a common electrode in the plasma display panel, the common-electrode driving circuit including a second sustaining-clamp circuit for applying a sustaining-discharge pulse to the common electrode, and a sub-voltage applying circuit for applying a sub-scanning-voltage to the common electrode, the second sustaining-clamp circuit including a fourth power-source terminal having a voltage higher than a ground voltage, a fifth switching device through which the fourth power-source terminal can be electrically connected to the common electrode, a second ground terminal having a ground voltage, and a sixth switching device through which the second ground terminal can be electrically connected to the common electrode, the sub-voltage applying circuit including a fifth power-source terminal having a voltage higher than a voltage of the fourth power-source terminal, and a sixth switching device through which the fifth power-source terminal can be electrically connected to the common electrode, the second sustaining-clamp circuit including a third current cut-off device which prevents a current from running to the fourth power-source terminal from the fifth power-source terminal, the third current-cut-off device being positioned in the second sustaining-clamp circuit in a current path other than a current path through which a current runs when the common electrode is electrically connected to the second ground terminal.

In the circuit in accordance with the present invention, since the third current cut-off device is positioned in the second sustaining-clamp circuit in a current path other than a current path through which a current runs when the common electrode is electrically connected to the second ground terminal, it is possible to reduce power loss caused by a current running through the third current cut-off device.

It a preferable embodiment, the common-electrode driving circuit further includes a second collection circuit which applies a voltage to the common electrode and collects a voltage from the common electrode, wherein the third current cut-off device is positioned in the first sustaining-clamp circuit in a current path other than a current path through which a current runs when the second collection circuit applies a voltage to the common electrode, or when the second collection circuit collects a voltage from the common electrode.

This embodiment ensures it possible to further reduce power loss caused by a current running through the third current cut-off device.

For instance, the third current cut-off device may comprise a switching device or a diode.

A circuit for driving a plasma display panel may be comprised of one of the above-mentioned scanning-electrode driving circuits and one of the above-mentioned common-electrode driving circuits.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a circuit diagram of a conventional circuit for driving a plasma display panel (PDP).

FIG. 2 is a timing chart showing an operation of the circuit illustrated in FIG. 1.

FIG. 3 is a circuit diagram of another conventional circuit for driving a plasma display panel.

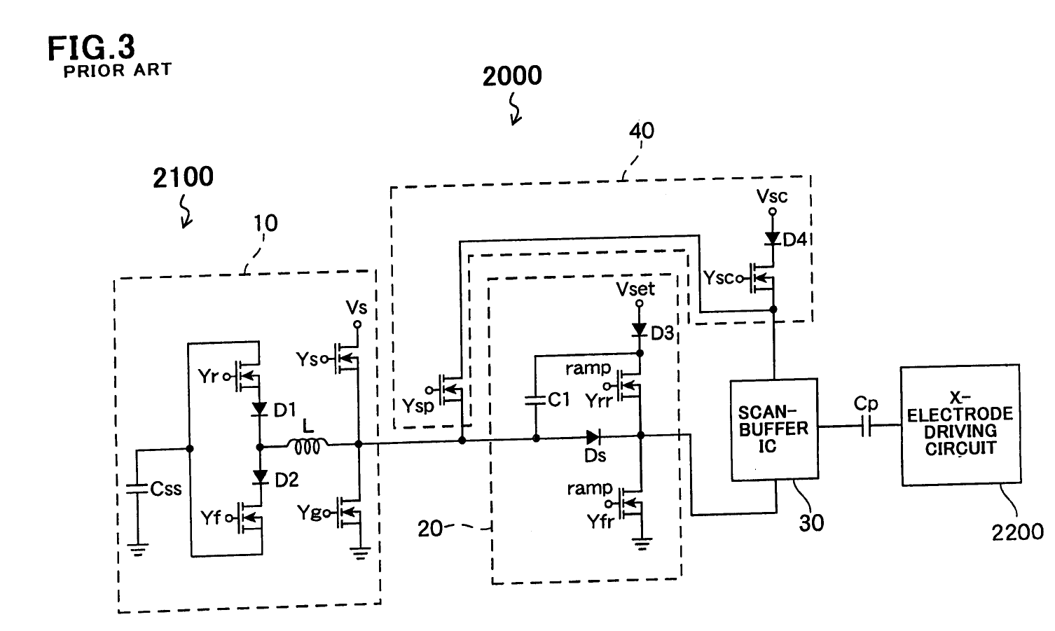

FIG. 4 is a circuit diagram of a circuit for driving a plasma display panel (PDP) in accordance with the first embodiment of the present invention.

FIG. 5 is a circuit diagram of a circuit for driving a plasma display panel (PDP) in accordance with the second embodiment of the present invention.

FIG. 6 is a circuit diagram of a circuit for driving a plasma display panel (PDP) in accordance with the third embodiment of the present invention.

FIG. 7 is a circuit diagram of a circuit for driving a plasma display panel (PDP) in accordance with the fourth embodiment of the present invention.

FIG. 8 is a circuit diagram of a circuit for driving a plasma display anel (PDP) in accordance with the fifth embodiment of the present invention.

FIG. 9 is a circuit diagram of a circuit for driving a plasma display anel (PDP) in accordance with the sixth embodiment of the present invention.

FIG. 10 is a circuit diagram of a circuit for driving a plasma display panel (PDP) in accordance with the seventh embodiment of the present invention.

FIG. 11 is a circuit diagram of a circuit for driving a plasma display panel (PDP) in accordance with the eighth embodiment of the present invention.

### DESCRIPTION OF THE PREFERRED EMBODIMENTS

Preferred embodiments in accordance with the present invention will be explained hereinbelow with reference to drawings.

[First Embodiment]

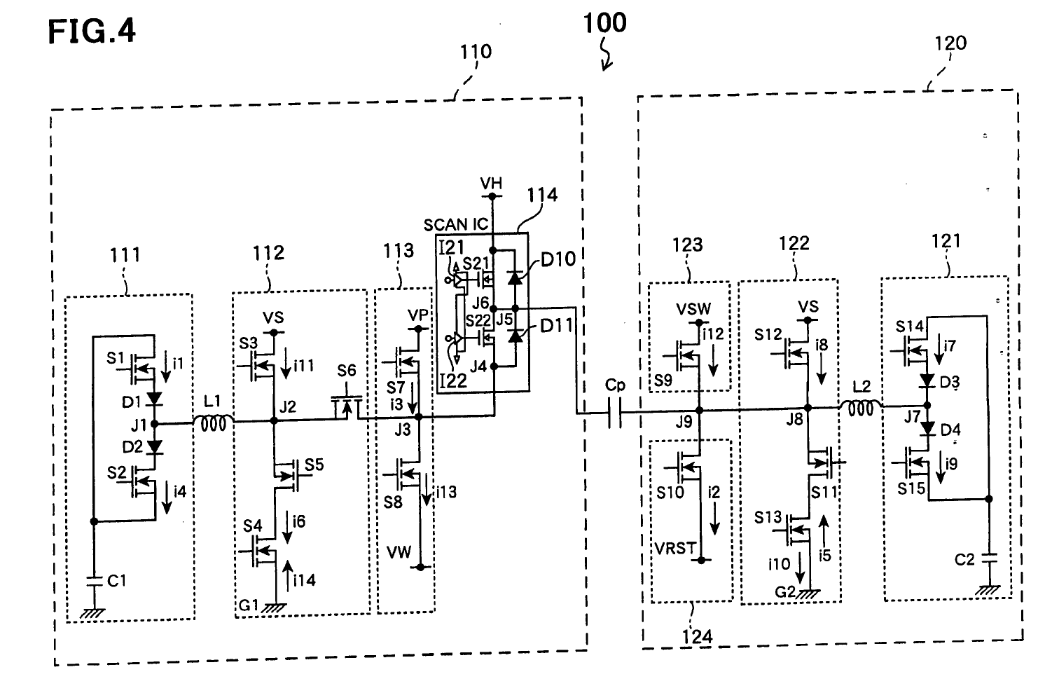

FIG. 4 is a circuit diagram of a circuit 100 for driving a plasma display panel Cp in accordance with the first embodiment of the present invention.

As illustrated in FIG. 4, the circuit 100 in accordance with the first embodiment includes a Y-electrode driving circuit 110 which applies a drive voltage to a terminal (hereinafter, referred to as “scanning-electrode terminal) of a Y electrode (scanning electrode) in a plasma display panel Cp, and a X-electrode driving circuit 120 which applies a drive voltage to a terminal (hereinafter, referred to as “common-electrode terminal) of a X electrode (common electrode) in the plasma display panel Cp.

The Y-electrode driving circuit 110 is comprised of a collection circuit 111, a sustaining-clamp circuit 112, a reset circuit (priming circuit) 113, a scanning IC 114, and a first coil L1 electrically connected between the collection circuit 111 and the sustaining-clamp circuit 112.

The collection circuit 111 is comprised of a first capacitor C1, a first transistor switch S1, a second transistor switch S2, a first diode D1, and a second diode D2.

The first capacitor C1 is grounded at one end thereof, and electrically connected at the other end to both a drain terminal of the first transistor S1 and a source terminal of the second transistor switch S2.

The first and second diodes D1 and D2 are electrically connected in series to each other between a source terminal of the first transistor switch S1 and a drain terminal of the second transistor switch S2.

Specifically, a source terminal of the first transistor switch S1 is electrically connected to an anode terminal of the first diode D1, a cathode terminal of the first diode D1 is electrically connected to an anode terminal of the second diode D2, and a cathode terminal of the second diode D2 is electrically connected to a drain terminal of the second transistor switch S2.

The sustaining-clamp circuit 112 includes third to sixth transistor switches S3 to S6.

The third transistor switch S3 has a drain terminal electrically connected to a power-source terminal VS, and a source terminal electrically connected to a drain terminal of the fifth transistor switch S5.

The fourth transistor switch S4 has a source terminal electrically connected to a ground terminal G1, and a drain terminal electrically connected to a drain terminal of the fifth transistor switch S5.

The sixth transistor switch S6 has a source terminal electrically connected to a second junction J2 at which the third and fifth transistor switches S3 and S5 are electrically connected to each other.

The first coil L1 is electrically connected at one end thereof to the second junction J2, and at the other end thereof to a first junction J1 at which the first and second diodes D1 and D2 are electrically connected to each other.

The reset circuit 113 is comprised of a seventh transistor switch S7 and an eighth transistor switch S8.

The seventh transistor switch S7 has a drain terminal electrically connected to a power-source terminal VP, and a source terminal electrically connected to a drain terminal of the eighth transistor switch S8.

The eighth transistor switch S8 has a source terminal electrically connected to a power-source terminal VW.

The sixth transistor switch S6 has a drain terminal electrically connected to a third junction J3 at which a source terminal of the seventh transistor switch S7 and a drain terminal of the eighth transistor switch S8 are electrically connected to each other.

The scanning IC 114 is comprised of a sixteenth transistor switch S21, a seventeenth transistor switch S22, a seventh diode D10, an eighth diode D11, a first inverter I22, and a second inverter I22.

The sixteenth transistor switch S21 has a drain terminal electrically connected to both a power-source terminal VH and a cathode terminal of the seventh diode D10, and a source terminal electrically connected to a drain terminal of the seventeenth transistor switch S22.

The seventeenth transistor switch S22 has a source terminal electrically connected to the above-mentioned third junction J3 and an anode terminal of the eighth diode D11.

The eighth diode D11 has a cathode terminal electrically connected to both an anode terminal of the seventh diode D10 and a sixth junction J6 at which a source terminal of the sixteenth transistor switch S21 and a drain terminal of the seventeenth transistor switch S22 are electrically connected to each other.

The first inverter I22 has an output terminal electrically connected to both a gate terminal of the sixteenth transistor switch S21 and an input terminal of the second inverter I22.

The second inverter I22 has an output terminal electrically connected to both a gate terminal of the seventeenth transistor switch S22 and an input terminal of the first inverter I22.

A fifth junction J5 at which the fifth and sixth diodes D10 and D11 are electrically connected to each other is electrically connected to the scanning-electrode terminal of the plasma display panel Cp.

The X-electrode driving circuit 120 is comprised of a collection circuit 121, a sustaining-clamp circuit 122, a sub-voltage applying circuit 123, a reset-enhancing circuit 124, and a second coil L1.

The sub-voltage applying circuit 123 includes a ninth transistor switch S9 having a drain terminal electrically connected to a power-source terminal VSW.

The reset-enhancing circuit 124 includes a tenth transistor switch S10 having a source terminal electrically connected to a power-source terminal VRST, and a drain terminal electrically connected to a source terminal of the ninth transistor switch S9.

A ninth junction J9 at which a source terminal of the ninth transistor switch S9 and a drain terminal of the tenth transistor switch S10 are electrically connected to each other is electrically connected to the common-electrode terminal of the plasma display panel Cp.

The sustaining-clamp circuit 122 includes eleventh to thirteenth transistor switches S11 to S13.

The thirteenth transistor switch S13 has a source terminal electrically connected to a ground terminal G2, and a drain terminal electrically connected to a drain terminal of the eleventh transistor switch S11.

The eleventh transistor switch S11 has a source terminal electrically connected to a source terminal of the twelfth transistor switch S12.

An eighth junction J8 at which a source terminal of the twelfth transistor switch S12 and a source terminal of the tenth transistor switch S10 are electrically connected to each other is electrically connected to the common-electrode terminal of the plasma display panel Cp through the ninth junction J9.

The twelfth transistor switch S12 has a drain terminal electrically connected to a power-source terminal VS.

The collection circuit 121 includes a fourteenth transistor switch S14, a fifteenth transistor switch S15, a third diode D3, a fourth diode D4, and a second pacitor C2.

The second capacitor C2 is grounded at one end thereof, and is electrically connected at the other end thereof to both a drain terminal of the fourteenth transistor switch S14 and a source terminal of the fifteenth transistor switch S15.

The third and fourth diodes D3 and D4 are electrically connected in series to each other between a source terminal of the fourteenth transistor switch S14 and a drain terminal of the fifteenth transistor switch S15.

Specifically, a source terminal of the fourteenth transistor switch S14 is electrically connected to an anode terminal of the third diode D3, a cathode terminal of the third diode D3 is electrically connected to an anode terminal of the fourth diode D4, and a cathode terminal of the fourth diode D4 is electrically connected to a drain terminal of the fifteenth transistor switch S15.

The second coil L1 is electrically connected at one end thereof to a seventh junction J7 at which the third and fourth diodes D3 and D4 are electrically connected to each other, and at the other end thereof to the common-electrode terminal of the plasma display panel Cp through the eighth and ninth junctions J8 and J9.

In the first embodiment, a voltage applied to the power-source terminal VP is higher than a voltage applied to the power-source terminal VS.

A voltage applied to the power-source terminal VSW is higher than a voltage applied to the power-source terminal VS.

The voltages applied to the power-source terminals VS, VP and VSW are higher than a voltage of the first and second ground terminals G1 and G2.

In contrast, the voltages applied to the power-source terminals VW and VRST are lower than a voltage of the first and second ground terminals G1 and G2.

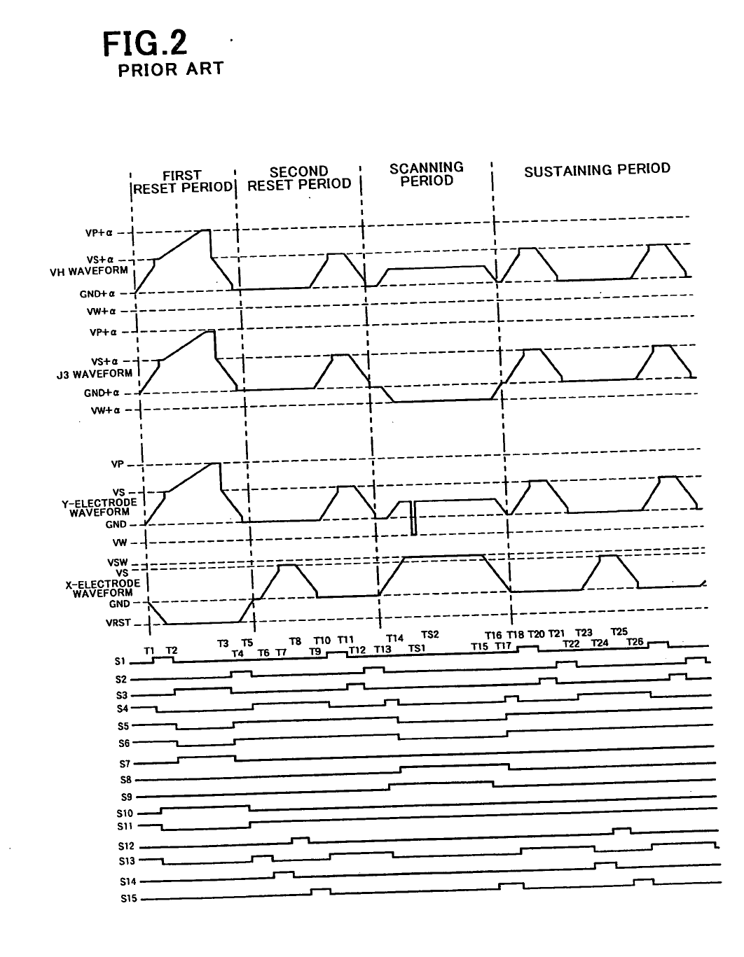

A voltage applied to the power-source terminal VH is higher than a voltage applied to the scanning-electrode terminal of the plasma display panel Cp by α except a scanning period (see FIG. 2).

Control signals are input into each of gate terminals of the first to fifteenth transistor switches S1 to S15 and each of input terminals of the first and second inverters I21 and I22 of the scanning IC 114. On/off control is made to the first to seventeenth transistor switches S1 to S15, S21 and S22 in accordance with the controls signals.

FIG. 2 is a timing chart showing an operation of the circuit 100 in accordance with the first embodiment.

FIG. 2 illustrates waveforms of control signals to be input into gate terminals of the first to fifteenth transistor switches S1 to S15, a waveform of a voltage to be applied to a scanning electrode of the plasma display panel Cp (Y-electrode waveform), a waveform of a voltage to be applied to a common electrode of the plasma display panel Cp (X-electrode waveform), a waveform of a voltage to be input into the power-source terminal VH (VH waveform), and a waveform of a voltage found at the third junction J3 (J3 waveform).

The PDP driving circuit 100 repeatedly carries out an operation including a first reset period, a second reset period, a scanning period, and a sustaining period, as illustrated in FIG. 2, in accordance with the control signals input into gate terminals of the first to fifteenth transistor switches S1 to S15 and the control signals input into input terminals of the first and second inverters I21 and I22.

In the first and second reset periods, wall charges remaining even after the sustaining period are reduced or eliminated. In the scanning period, data-writing discharge is generated to select a cell to be turned on. In the sustaining period, sustaining discharge is generated in the cell having been selected in the scanning period to thereby emit a light therefrom.

As illustrated in FIG. 2, at first in the first reset period, the transistor switches S1, S2, S3, S7, S8, S9, S10, S12, S14 and S15 are turned off, whereas the transistor switches S4, S5, S6, S11 and S13 are turned on.

The sixteenth transistor switch S21 in the scanning IC 114 is turned off, whereas the seventeenth transistor switch S22 is turned on.

Accordingly, a voltage which is applied to the scanning-electrode terminal of the plasma display panel Cp by the Y-electrode driving circuit 110 is equal to a voltage of the ground terminal G1, and a voltage which is applied to the common-electrode terminal of the plasma display panel Cp by the X-electrode driving circuit 120 is equal to a voltage of the ground terminal G2.

The waveform of the power-source terminal VH is higher than the Y-electrode waveform by α. The waveform at the third junction J3 is higher than the Y-electrode waveform by α except the scanning period.

At a timing T1 in the first reset period, the first and tenth transistor switches S1 and S10 are turned on, whereas the fourth, eleventh and thirteenth transistor switches S4, S11 and S13 are turned off.

Thus, in the Y-electrode driving circuit 110, a current i1 runs to the scanning-electrode terminal of the plasma display panel Cp from the first capacitor C1 of the collection circuit 111 through the first transistor switch S1, the first diode D1, the first junction J1, the first coil L1, the second junction J2, the sixth transistor switch S6, the third junction J3, a fourth junction J4 (a junction at which the seventeenth transistor switch S22 and the third junction J3 are electrically connected to each other), the eighth diode D11, and the fifth junction J5 in this order.

In the X-electrode driving circuit 120, a current i2 runs to the power-source terminal VRST from the common-electrode terminal of the plasma display panel Cp through the ninth junction J9 and the tenth transistor switch S10 in this order.

As a result, a voltage applied by the Y-electrode driving circuit 110 to the scanning electrode of the plasma display panel Cp increases to a voltage of the power-source terminal VS from a voltage of the ground terminal G1, and a voltage applied by the X-electrode driving circuit 120 to the common electrode of the plasma display panel Cp decreases to a voltage of the power-source terminal VRST from a voltage of the ground terminal G2.

At a timing T2 in the first reset period, the first, fifth and sixth transistor switches S1, S5 and S6 are turned off, whereas the third and seventh transistor switches S3 and S7 are turned on.

As a result, in the Y-electrode driving circuit 110, a current i3 runs to the scanning-electrode terminal of the plasma display panel Cp from the power-source terminal VP of the reset circuit 113 through the seventh transistor switch S7, the third junction J3, the fourth junction J4, the eighth diode D11 and the fifth junction J5 in this order.

Accordingly, a voltage applied by the Y-electrode driving circuit 110 to the scanning electrode of the plasma display panel Cp increases to a voltage of the power-source voltage VP from a voltage of the power-source terminal VS, and a voltage applied by the X-electrode driving circuit 120 to the common electrode of the plasma display panel Cp is kept equal to a voltage of the power-source terminal VRST.

At a timing T3 in the first reset period, the second, fifth and sixth transistor switches S2, S5 and S6 are turned on, whereas the third and seventh transistor switches S3 and S7 are turned off.

As a result, in the Y-electrode driving circuit 110, a current i4 runs to the first capacitor C1 of the collection circuit 111 from the scanning electrode of the plasma display panel Cp through the fifth junction J5, the sixth junction J6, the seventeenth transistor switch S22, the fourth junction J4, the third junction J3, the sixth transistor switch S6, the second junction J2, the first coil L1, the first junction J1, and the second transistor switch S2 in this order.

Accordingly, a voltage applied by the Y-electrode driving circuit 110 to the scanning electrode of the plasma display panel Cp steeply decreases to a voltage of the power-source terminal VS from a voltage of the power-source terminal VP, and then, gradually decreases from a voltage of the power-source terminal VS.

At a timing T4 in the first reset period, the eleventh and thirteenth transistor switches S11 and S13 are turned on, whereas the tenth transistor switch S10 is turned off.

As a result, in the X-electrode driving circuit 120, a current i5 runs to the scanning-electrode terminal of the plasma display panel Cp from the ground terminal G2 through the thirteenth transistor switch S13, the eleventh transistor switch S11, the eighth junction J8, and the ninth junction J9 in this order.

Accordingly, a voltage applied by the X-electrode driving circuit 120 to the common electrode of the plasma display panel Cp gradually increases to a ground voltage from a voltage of the power-source terminal VRST.

At a timing T5 in the first reset period, the fourth transistor switch S4 is turned on, whereas the second transistor switch S2 is turned off.

As a result, in the Y-electrode driving circuit 110, a current i6 runs to the ground terminal G1 from the scanning-electrode terminal of the plasma display panel Cp through the fifth junction J5, the sixth junction J6, the seventeenth transistor switch S22, the fourth junction J4, the third junction J3, the sixth transistor switch S6, the second junction J2, the fifth transistor switch S5, and the fourth transistor switch S4 in this order.

Accordingly, a voltage applied by the Y-electrode driving circuit 110 to the scanning electrode of the plasma display panel Cp steeply decreases to a voltage of the ground terminal G1.

The first reset period is defined as a period in which a voltage applied by the X-electrode driving circuit 120 to the common electrode of the plasma display panel Cp increases to a voltage of the ground terminal G2.

At a timing T6 in the second reset period, the thirteenth transistor switch S13 is turned off, whereas the fourteenth transistor switch S14 is turned on.

As a result, in the X-electrode driving circuit 120, a current i7 runs to the common-electrode terminal of the plasma display panel Cp from the second capacitor C2 through the fourteenth transistor switch S14, the seventh junction J7, the second coil L2, the eighth junction J8, and the ninth junction J9 in this order.

Accordingly, a voltage applied by the X-electrode driving circuit 120 to the common electrode of the plasma display panel Cp gradually increases from a voltage of the ground terminal G2.

At a timing T7 in the second reset period, the twelfth transistor switch S12 is turned on, whereas the fourteenth transistor switch S14 is turned off.

As a result, in the X-electrode driving circuit 120, a current i8 runs to the common-electrode terminal of the plasma display panel Cp from the power-source terminal VS through the twelfth transistor switch S12, the eighth junction J8, and the ninth junction J9 in this order.

Accordingly, a voltage applied by the X-electrode driving circuit 120 to the common electrode of the plasma display panel Cp steeply increases to a voltage of the power-source terminal VS.

At a timing T8 in the second reset period, the twelfth transistor switch S12 is turned off, whereas the fifteenth transistor switch S15 is turned on.

As a result, in the X-electrode driving circuit 120, a current i9 runs to the second capacitor C2 from the common-electrode terminal of the plasma display panel Cp through the ninth junction J9, the eighth junction J8, the second coil L2, the seventh junction J7, the fourth diode D4, and the fifteenth transistor switch S15 in this order.

Accordingly, a voltage applied by the X-electrode driving circuit 120 to the common electrode of the plasma display panel Cp gradually decreased from a voltage of the power-source terminal VS.

At a timing T9 in the second reset period, the thirteenth transistor switch S13 is turned on, whereas the fifteenth transistor switch S15 is turned off.

As a result, in the X-electrode driving circuit 120, a current i10 runs to the ground terminal G2 from the common-electrode terminal of the plasma display panel Cp through the ninth junction J9, the eighth junction J8, the eleventh transistor switch S11, and the thirteenth transistor switch S13 in this order.

Accordingly, a voltage applied by the X-electrode driving circuit 120 to the common electrode of the plasma display panel Cp steeply decreases to a voltage of the ground terminal G2.

At a timing T10 in the second reset period, the first transistor switch S1 is turned on, whereas the fourth transistor switch S4 is turned off.

As a result, in the Y-electrode driving circuit 110, a current i11 runs to the scanning-electrode terminal of the plasma display panel Cp from the first capacitor C1 through the first transistor switch S1, the first diode D1, the first junction J1, the first coil L1, the second junction J2, the sixth transistor switch S6, the third junction J3, the fourth junction J4, the eighth diode D11, and the fifth junction J5 in this order.

Accordingly, a voltage applied by the Y-electrode driving circuit 110 to the scanning electrode of the plasma display panel Cp gradually increases.

At a timing T11 in the second reset period, the first transistor switch S1 is turned off, whereas the third transistor switch S3 is turned on.

As a result, in the Y-electrode driving circuit 110, a current i11 runs to the scanning-electrode terminal of the plasma display panel Cp from the power-source terminal VS through the third transistor switch S3, the second junction J2, the sixth transistor switch S6, the third junction J3, the fourth junction J4, the eighth diode D1l, and the fifth junction J5 in this order.

Accordingly, a voltage applied by the Y-electrode driving circuit 110 to the scanning electrode of the plasma display panel C steeply increases to a voltage of the power-source terminal VS.

At a timing T12 in the second reset period, the second transistor switch S2 is turned on, whereas the third transistor switch S3 is turned off.

As a result, in the Y-electrode driving circuit 110, a current i4 runs to the first capacitor C1 from the scanning electrode of the plasma display panel Cp through the fifth junction J5, the sixth junction J6, the seventeenth transistor switch S22, the fourth junction J4, the third junction J3, the sixth transistor switch S6, the second junction J2, the first coil L1, the first junction J1, and the second transistor switch S2 in this order.

Accordingly, a voltage applied by the Y-electrode driving circuit 110 to the scanning electrode of the plasma display panel C gradually decreases from a voltage of the power-source terminal VS.

At a timing T13 at which the scanning period starts, the second and thirteenth transistor switches S2 and S13 are turned off, whereas the fourth and ninth transistor switches S4 and S9 are turned on.

As a result, in the Y-electrode driving circuit 110, a current i6 runs to the ground terminal G1 from the scanning electrode of the plasma display panel Cp through the fifth junction J5, the sixth junction J6, the seventeenth transistor switch S22, the fourth junction J4, the third junction J3, the sixth transistor switch S6, the second junction J2, the fifth transistor switch S5, and the fourth transistor switch S4 in this order.

Further, in the X-electrode driving circuit 120, a current i12 runs to the common-electrode terminal of the plasma display panel Cp from the power-source terminal VSW through the ninth transistor switch S9 and the ninth junction J9 in this order.

Accordingly, a voltage applied by the Y-electrode driving circuit 110 to the scanning electrode of the plasma display panel Cp steeply decreases to a voltage of the ground terminal G1, and a voltage applied by the X-electrode driving circuit 120 to the common electrode of the plasma display panel Cp gradually increases to a voltage of the power-source terminal VSW.

At a timing T14 in the scanning period, the fourth, fifth and sixth transistor switches S4, S5 and S6 are turned off, whereas the eighth transistor witch S8 is turned on.

Further, at the timing T14, the sixteenth transistor switch S21 is turned on, whereas the seventeenth transistor switch S22 is turned off.

As a result, in the Y-electrode driving circuit 110, a current runs to the scanning electrode of the plasma display panel Cp from the power-source terminal VH through the sixteenth transistor switch S21, the sixth junction J6, and the fifth junction J5 in this order.

Accordingly, a voltage applied by the Y-electrode driving circuit 110 to the scanning electrode of the plasma display panel Cp gradually increases from a voltage of the ground terminal G1.

A voltage of the power-source terminal VH gradually increases from a sum of a ground voltage and α.

Further, a voltage of the third junction J3 gradually decreases to a sum of a voltage of the power-source terminal VW and a from a sum of a ground voltage and α.

In a line selected in the scanning period, after a timing TS1 at which the sixteenth transistor switch S21 was turned off and the seventeenth transistor switch S22 was turned on, the sixteenth transistor switch S21 is turned on and the seventeenth transistor switch S22 is turned off at a timing TS2.

As a result, during the timing TS1 and the timing TS2 in the Y-electrode driving circuit 110, a current il3 runs to the power-source terminal VW from the scanning electrode of the plasma display panel Cp through the fifth junction J5, the sixth junction J6, the seventeenth transistor switch S22, the fourth junction J4, the third junction J3, and the eighth transistor switch S8 in this order.

Accordingly, a voltage applied by the Y-electrode driving circuit 110 to the scanning electrode of the plasma display panel Cp steeply decreases to a voltage of the power-source terminal VW.

At the timing TS2, a current runs to the scanning electrode of the plasma display panel Cp from the power-source terminal VH through the sixteenth transistor switch S21, the sixth junction J6, and the fifth junction J5 in this order.

Accordingly, a voltage applied by the Y-electrode driving circuit 110 to the scanning electrode of the plasma display panel Cp steeply increases from a voltage of the power-source terminal VW.

The above-mentioned selection (that is, data-writing) is carried out to every selected line in order.

At a timing T15 in the scanning period, the ninth transistor switch S9 is turned off, whereas the fifteenth transistor switch S15 is turned on.

As a result, in the X-electrode driving circuit 120, a current i9 runs to the second capacitor C2 from the common electrode of the plasma display panel Cp through the ninth junction J9, the eighth junction J8, the second coil L2, the fourth diode D4, and the fifteenth transistor switch S15 in this order.

Accordingly, a voltage applied by the X-electrode driving circuit 120 to the common electrode of the plasma display panel Cp gradually decreases from a voltage of the power-source terminal VSW.

At a timing T16 in the scanning period, the fourth, fifth and sixth transistor switches S4, S5 and S6 are turned on, whereas the eighth transistor switch S8 is turned off.

Further, at the timing T16, the sixteenth transistor switch S21 is turned off, whereas the seventeenth transistor switch S22 is turned on.

As a result, in the Y-electrode driving circuit 110, a current i6 runs to the ground terminal G1 from the scanning-electrode terminal of the plasma display panel Cp through the fifth junction J5, the sixth junction J6, the seventeenth transistor switch S22, the fourth junction J4, the third junction J3, the sixth transistor switch S6, the second junction J2, and the fifth transistor switch S5 in this order.

Accordingly, a voltage applied by the Y-electrode driving circuit 110 to the scanning electrode of the plasma display panel Cp gradually decreases to a voltage of the ground terminal G1.

A voltage of the power-source terminal VH gradually decreases to a sum of a ground voltage and α, and a voltage of the third junction J3 gradually increases to a sum of a ground voltage and α.

At a timing T17 at which the sustaining period starts, the thirteenth transistor switch S13 is turned on, whereas the fifteenth transistor switch S15 is turned off.

As a result, in the X-electrode driving circuit 120, a current i10 runs to the ground terminal G2 from the common-electrode terminal of the plasma display panel Cp through the ninth junction J9, the eighth junction J8, the eleventh transistor switch S11, and the thirteenth transistor switch S13 in this order.

Accordingly, a voltage applied by the X-electrode driving circuit 120 to the common electrode of the plasma display panel Cp steeply decreases to a voltage of the ground terminal G2.

At a timing T18 in the sustaining period, the first transistor switch S1 is turned on, whereas the fourth transistor switch S4 is turned off.

As a result, in the Y-electrode driving circuit 110, a current i1 runs to the scanning-electrode terminal of the plasma display panel Cp from the first capacitor C1 through the first transistor switch S1, the first diode D1, the first junction J1, the first coil L1, the second junction J2, the sixth transistor switch S6, the third junction J3, the fourth junction J4, the eighth diode D11, and the fifth junction J5 in this order.

Accordingly, a voltage applied by the Y-electrode driving circuit 110 to the scanning electrode of the plasma display panel Cp gradually increases from a voltage of the ground terminal G1.

At a timing T20 in the sustaining period, the first transistor switch S1 is turned off, whereas the third transistor switch S3 is turned on.

As a result, in the Y-electrode driving circuit 110, a current i11 runs to the scanning-electrode terminal of the plasma display panel Cp from the power-source terminal VS through the third transistor switch S3, the second junction J2, the sixth transistor switch S6, the third junction J3, the fourth junction J4, the eighth diode D11, and the fifth junction J5 in this order.

Accordingly, a voltage applied by the Y-electrode driving circuit 110 to the scanning electrode of the plasma display panel Cp steeply increases to a voltage of the power-source terminal VS.

At a timing T21 in the sustaining period, the second transistor switch S2 is turned on, whereas the third transistor switch S3 is turned off.

As a result, in the Y-electrode driving circuit 110, a current i4 runs to the first capacitor C1 from the scanning electrode of the plasma display panel Cp through the fifth junction J5, the sixth junction J6, the seventeenth transistor switch S22, the fourth junction J4, the third junction J3, the sixth transistor switch S6, the second junction J2, the first coil L1, the first junction J1, and the second transistor switch S2 in this order.

Accordingly, a voltage applied by the Y-electrode driving circuit 110 to the scanning electrode of the plasma display panel Cp gradually decreases from a voltage of the power-source terminal VS.

At a timing T22 in the sustaining period, the second transistor switch S2 is turned off, whereas the fourth transistor switch S4 is turned on.

As a result, in the Y-electrode driving circuit 110, a current i6 runs to the ground terminal G1 from the scanning electrode of the plasma display panel Cp through the fifth junction J5, the sixth junction J6, the seventeenth transistor switch S22, the fourth junction J4, the third junction J3, the sixth transistor switch S6, the second junction J2, the fifth transistor switch S5, and the fourth transistor switch S4 in this order.

Accordingly, a voltage applied by the Y-electrode driving circuit 110 to the scanning electrode of the plasma display panel Cp steeply decreases to a voltage of the ground terminal G1.

At a timing T23 in the sustaining period, the thirteenth transistor switch S13 is turned off, whereas the fourteenth transistor switch S14 is turned on.

As a result, in the X-electrode driving circuit 120, a current i7 runs to the common-electrode terminal of the plasma display panel Cp from the second capacitor C2 through the fourteenth transistor switch S14, the seventh junction J7, the second coil L2, the eighth junction J8, and the ninth junction J9 in this order.

Accordingly, a voltage applied by the X-electrode driving circuit 120 to the common electrode of the plasma display panel Cp gradually increases from a voltage of the ground terminal G2.

At a timing T24 in the sustaining period, the twelfth transistor switch S12 is turned on, whereas the fourteenth transistor switch S14 is turned off.

As a result, in the X-electrode driving circuit 120, a current i8 runs to the common-electrode terminal of the plasma display panel Cp from the power-source terminal VS through the twelfth transistor switch S12, the eighth junction J8, and the ninth junction J9 in this order.

Accordingly, a voltage applied by the X-electrode driving circuit 120 to the common electrode of the plasma display panel Cp steeply increases to a voltage of the power-source terminal VS.

At a timing T25 in the sustaining period, the twelfth transistor switch S12 is turned off, whereas the fourteenth transistor switch S14 is turned on.

As a result, in the X-electrode driving circuit 120, a current i9 runs to the second capacitor C2 from the common-electrode terminal of the plasma display panel Cp through the ninth junction J9, the eighth junction J8, the second coil L2, the seventh junction J7; the fourth diode D4, and the fifteenth transistor switch S15 in this order.

Accordingly, a voltage applied by the X-electrode driving circuit 120 to the common electrode of the plasma display panel Cp gradually decreases from a voltage of the power-source terminal VS.

At a timing T26 in the sustaining period, the thirteenth transistor switch S13 is turned on, whereas the fifteenth transistor switch S15 is turned off.

As a result, in the X-electrode driving circuit 120, a current i10 runs to the ground terminal G2 from the common-electrode terminal of the plasma display panel Cp through the ninth junction J9, the eighth junction J8, the eleventh transistor switch S11, and the thirteenth transistor switch S13 in this order.

Accordingly, a voltage applied by the X-electrode driving circuit 120 to the common electrode of the plasma display panel Cp steeply decreases to a voltage of the ground terminal G2.

Hereinafter, the operations carried out at the timings T18 to T26 are repeatedly carried out by the number of sustaining-discharge pulses, and then, the operation in the first reset period restarts.

Among the parts constituting the circuit 100, the fifth transistor switch S5 acts as a cut switch for preventing a current from running into the power-source terminal VW having a negative voltage from the ground terminal G1.

Similarly, the sixth transistor switch S6 acts as a cut switch for preventing a current from running into the power-source terminal VS from the power-source terminal VP having a voltage higher than a voltage of the power-source terminal VS.

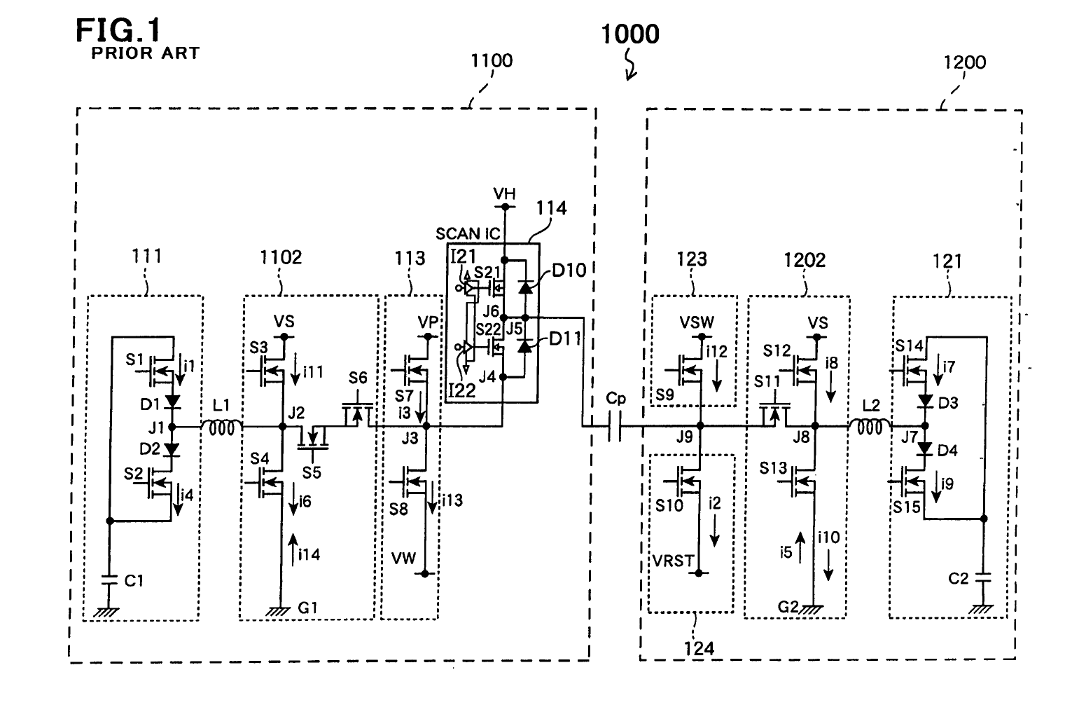

Similarly, the eleventh transistor switch S11 acts as a cut switch for preventing a current from running into the power-source terminal VRST having a negative voltage from the ground terminal G2.

Whereas the fifth transistor switch S5 is positioned between the second and third junctions J2 and J3 in the conventional circuit 1000 illustrated in FIG. 1, the fifth transistor switch S5 in the first embodiment is positioned between the second junction J2 and the fourth transistor switch S4, as illustrated in FIG. 4.

Specifically, in the first embodiment, the fifth transistor switch S5 acting as a first current cut-off device is positioned in the sustaining-clamp circuit 112 in a current path other than a current path (that is, a path between the second and third junctions J2 and J3) through which the currents i11, i1 and i4 run when a voltage is applied to the scanning electrode through the power-source terminal VS, when the collection circuit 111 applies a voltage to the scanning electrode, or when the collection circuit 111 collects a voltage from the scanning electrode.

Accordingly, the currents i11, i1 and i4 do not run through the fifth transistor switch S5 in the first embodiment, ensuring it possible to reduce power loss in comparison with the conventional circuit 1000 illustrated in FIG. 1.

Whereas the eleventh transistor switch S11 is positioned between the ninth and eighth junctions J9 and J8 in the conventional circuit 1000 illustrated in FIG. 1, the eleventh transistor switch S11 in the first embodiment is positioned between the eighth junction J8 and the thirteenth transistor switch S13, as illustrated in FIG. 4.

Specifically, in the first embodiment, the eleventh transistor switch S11 acting as a third current cut-off device is positioned in the sustaining-clamp circuit 122 in a current path other than a current path (that is, a path between the ninth and eighth junctions J9 and J8) through which the currents i8, i7 and i9 run when a voltage is applied to the common electrode through the power-source terminal VS, when the collection 121 circuit applies a voltage to the common electrode, or when the collection circuit 121 collects a voltage from the common electrode.

Accordingly, the currents i8, i7 and i9 do not run through the eleventh transistor switch S11 in the first embodiment, ensuring it possible to reduce power loss in comparison with the conventional circuit 1000 illustrated in FIG. 1.

In accordance with the first embodiment, the circuit 100 includes the scanning-electrode driving circuit 110 for applying a drive voltage to the scanning electrode of the plasma display panel Cp. The scanning-electrode driving circuit 110 includes the sustaining-clamp circuit 112 for applying a sustaining-discharge pulse to the scanning electrode, and the reset circuit 113 for applying a reset pulse to the scanning electrode. The sustaining-clamp circuit 112 includes the power-source terminal having a voltage higher than a ground voltage, the third transistor switch S3 through which the power-source terminal VS can be electrically connected to the scanning electrode, the ground terminal G1 having a ground voltage, and the fourth transistor switch S4 through which the ground terminal G1 can be electrically connected to the scanning electrode. The reset circuit 113 includes the power-source terminal VW having a voltage lower than the ground voltage, and the eighth transistor switch S8 through which the power-source terminal VW can be electrically connected to the scanning electrode. The sustaining-clamp circuit 112 includes the fifth transistor switch S5 acting as a first current cut-off device which prevents a current from running to the power-source terminal VW from the ground terminal G1. The fifth transistor switch S5 (the first current cut-off device) is positioned in the sustaining-clamp circuit 112 in a current path other than a current path through which a current i11 runs when a voltage is applied to the scanning electrode through the power-source terminal VS.

Thus, the current ill does not run through the fifth transistor switch S5, making it possible to reduce power loss caused by a current running through the fifth transistor switch S5.

In accordance with the first embodiment, the circuit 100 includes the common-electrode driving circuit 120 for applying a drive voltage to a common electrode of the plasma display panel Cp. The common-electrode driving circuit 120 includes the sustaining-clamp circuit 122 for applying a sustaining-discharge pulse to the common electrode, and the reset-enhancing circuit 124 which applies a pulse to the common electrode for enhancing resetting performance of the common electrode. The sustaining-clamp circuit 122 includes the power-source terminal VS having a voltage higher than a ground voltage, the twelfth transistor switch S12 through which the power-source terminal VS can be electrically connected to the common electrode, the ground terminal G2 having a ground voltage, and the thirteenth transistor switch S13 through which the ground terminal G2 can be electrically connected to the common electrode. The reset-enhancing circuit 124 includes the power-source terminal VRST having a voltage lower than a ground voltage, and the tenth transistor switch S10 through which the power-source terminal VRST can be electrically connected to the common electrode. The sustaining-clamp circuit 122 includes the eleventh transistor switch S11 acting as a third current cut-off device which prevents a current from running to the power-source terminal VRST from the ground terminal G2. The eleventh transistor switch Sl (the third current cut-off device) is positioned in the sustaining-clamp circuit 122 in a current path other than a current path through which the current i8 runs when a voltage is applied to the common electrode through the power-source terminal VS.

Thus, the current i8 does not run through the eleventh transistor switch S11, making it possible to reduce power loss caused by a current running through the eleventh transistor switch S11.

[Second Embodiment]

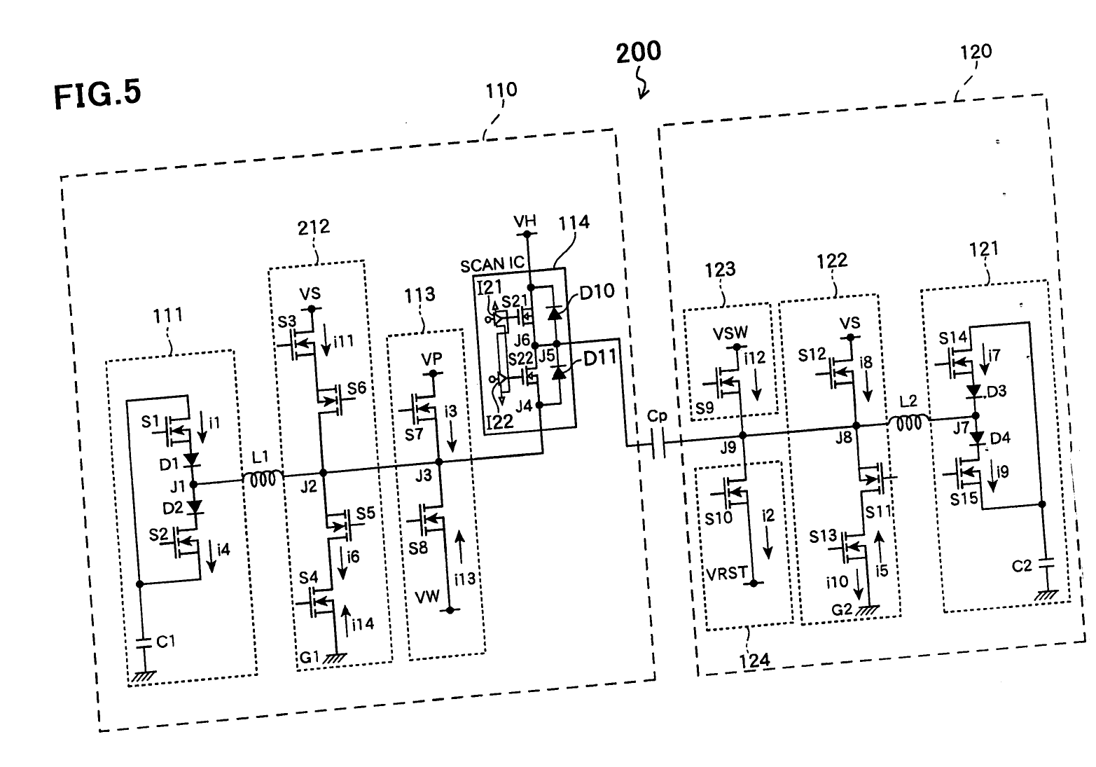

FIG. 5 is a circuit diagram of a circuit 200 for driving a plasma display panel (PDP) in accordance with the second embodiment of the present invention.

The circuit 200 in accordance with the second embodiment is structurally different from the circuit 100 in accordance with the first embodiment only in the later-mentioned difference. Hence, parts or elements that correspond to the circuit 100 have been provided with the same reference numerals, and operate in the same manner as corresponding parts or elements in the first embodiment, unless explicitly explained hereinbelow.

As illustrated in FIG. 5, the circuit 200 in accordance with the second embodiment is structurally different from the circuit 100 in accordance with the first embodiment only in including a sustaining-clamp circuit 212 in place of the sustaining-clamp circuit 112.

Specifically, the sixth transistor switch S6 as a part of the sustaining-clamp circuit 212 in the second embodiment is designed to have a source terminal electrically connected to a source terminal of the third transistor switch S3 without through the second junction J2, and a drain terminal electrically connected to the second junction J2.

In the circuit 200 in accordance with the second embodiment, the sixth transistor switch S6 acting as a second current cut-off device is positioned in the sustaining-clamp circuit 212 in a current path other than a current path through which the currents i6, i1 and i4 run when the scanning electrode is electrically connected to the ground terminal G1, when the collection circuit 111 applies a voltage to the scanning electrode, or when the collection circuit 111 collects a voltage from the scanning electrode.

Thus, in the circuit 200 in accordance with the second embodiment, the currents i6, i1 and i4 do not run through the sixth transistor switch S6, making it possible to further reduce power loss in comparison with the circuit 100 in accordance with the first embodiment.

The circuit 200 in accordance with the second embodiment provides the same advantages as those provided by the circuit 100 in accordance with the first embodiment.

Furthermore, the circuit 200 for driving a plasma display panel, includes the scanning-electrode driving circuit 110 for applying a drive voltage to a scanning electrode of the plasma display panel Cp. The scanning-electrode driving circuit 110 includes the sustaining-clamp circuit 212 for applying a sustaining-discharge pulse to the scanning electrode, and the reset circuit 113 for applying a reset pulse to the scanning electrode. The first sustaining-clamp circuit 212 includes the power-source terminal VS, the third transistor switch S3 acting as a first switching device through which the power-source terminal VS can be electrically connected to the scanning electrode, and the ground terminal G1 having a ground voltage. The reset circuit 113 includes the power-source terminal VP having a voltage higher than a voltage of the power-source terminal VS, and the seventh transistor switch S7 through which the power-source terminal VP can be electrically connected to the scanning electrode. The first sustaining-clamp circuit 212 includes the sixth transistor switch S6 acting as a second current cut-off device which prevents a current from running to the power-source terminal VS from the power-source terminal VP. The sixth transistor switch S6 is positioned in the sustaining-clamp circuit 212 in a current path other than a current path through which a current runs when the scanning electrode is electrically connected to the ground terminal G1.

Thus, the current i6 does not run through the sixth transistor switch S6, making it possible to reduce power loss caused by a current running through the sixth transistor switch S6.

[Third Embodiment]

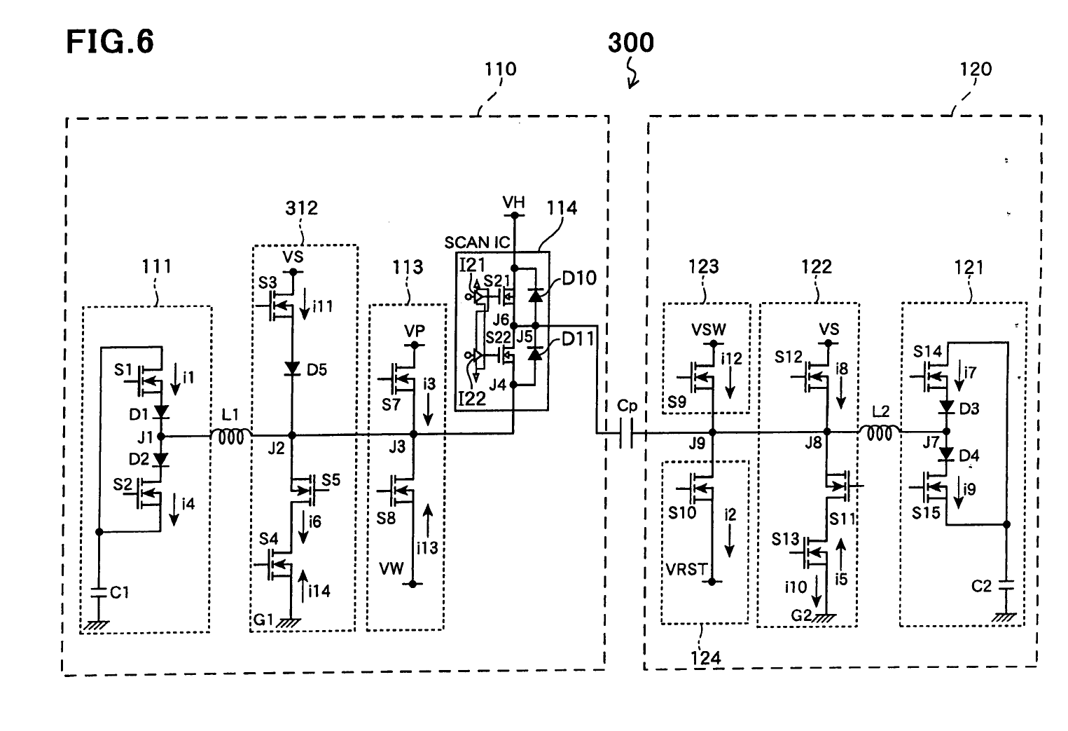

FIG. 6 is a circuit diagram of a circuit 300 for driving a plasma display panel (PDP) in accordance with the third embodiment of the present invention.

The circuit 300 in accordance with the third embodiment is structurally different from the circuit 200 in accordance with the second embodiment only in the later-mentioned difference. Hence, parts or elements that correspond to the circuit 200 have been provided with the same reference numerals, and operate in the same manner as corresponding parts or elements in the first embodiment, unless explicitly explained hereinbelow.

As illustrated in FIG. 6, the circuit 300 in accordance with the third embodiment is structurally different from the circuit 200 in accordance with the second embodiment only in including a sustaining-clamp circuit 312 in place of the sustaining-clamp circuit 212.

In the circuit 300 in accordance with the third embodiment, a fifth diode D5 acting as a second current cut-off device is electrically connected in place of the sixth transistor switch S6 between a source terminal of the third transistor switch S3 and the second junction J2.

Specifically, the fifth diode D5 has an anode terminal electrically connected to a source terminal of the third transistor switch S3, and a cathode terminal electrically connected to the second junction J2.

Similarly to the sixth transistor switch S6 in the second embodiment, the fifth diode D5 prevents a current from running to the power-source terminal VS from the power-source terminal VP.

The circuit 300 in accordance with the third embodiment provides the same advantages as those provided by the circuit 200 in accordance with the second embodiment.

[Fourth Embodiment]

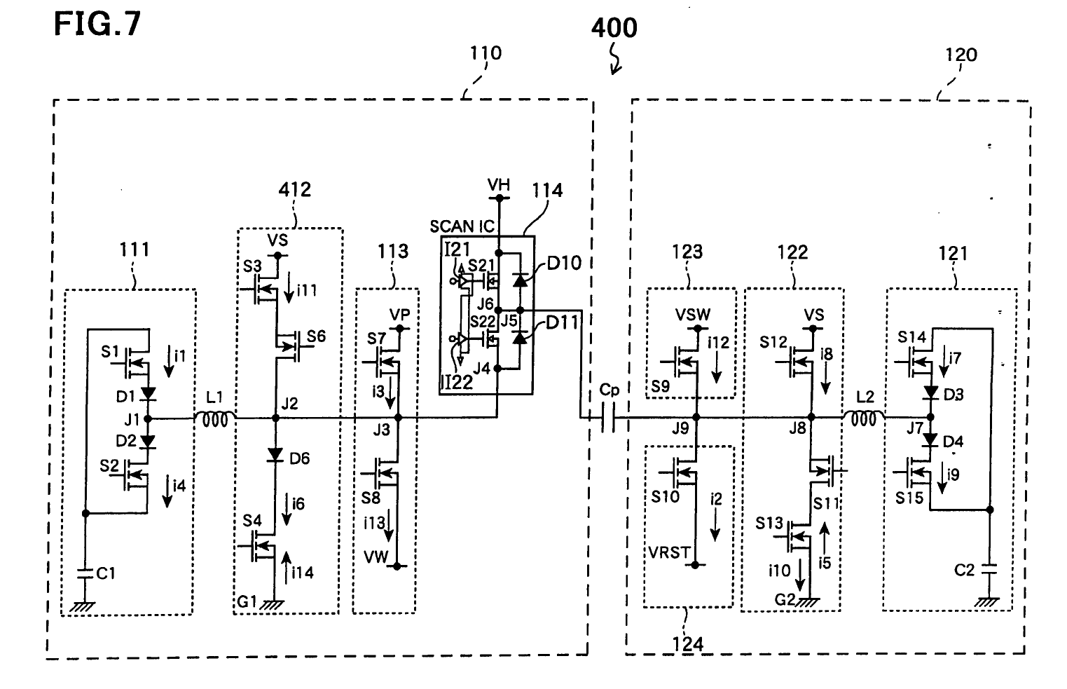

FIG. 7 is a circuit diagram of a circuit 400 for driving a plasma display panel (PDP) in accordance with the fourth embodiment of the present invention.

The circuit 400 in accordance with the fourth embodiment is structurally different from the circuit 200 in accordance with the second embodiment only in the later-mentioned difference. Hence, parts or elements that correspond to the circuit 200 have been provided with the same reference numerals, and operate in the same manner as corresponding parts or elements in the first embodiment, unless explicitly explained hereinbelow.

As illustrated in FIG. 7, the circuit 400 in accordance with the fourth embodiment is structurally different from the circuit 200 in accordance with the second embodiment only in including a sustaining-clamp circuit 412 in place of the sustaining-clamp circuit 212.

In the circuit 400 in accordance with the fourth embodiment, a sixth diode D6 acting as a first current cut-off device is electrically connected in place of the fifth transistor switch S5 between a drain terminal of the fourth transistor switch S4 and the second junction J2.

Specifically, the sixth diode D6 has an anode terminal electrically connected to the second junction J2, and a cathode terminal electrically connected to a drain terminal of the fourth transistor switch S4.

Similarly to the fifth transistor switch S5 in the second embodiment, the sixth diode D6 prevents a current from running to the power-source terminal VW from the ground terminal G1.

The circuit 400 in accordance with the fourth embodiment provides the same advantages as those provided by the circuit 200 in accordance with the second embodiment.

[Fifth Embodiment]

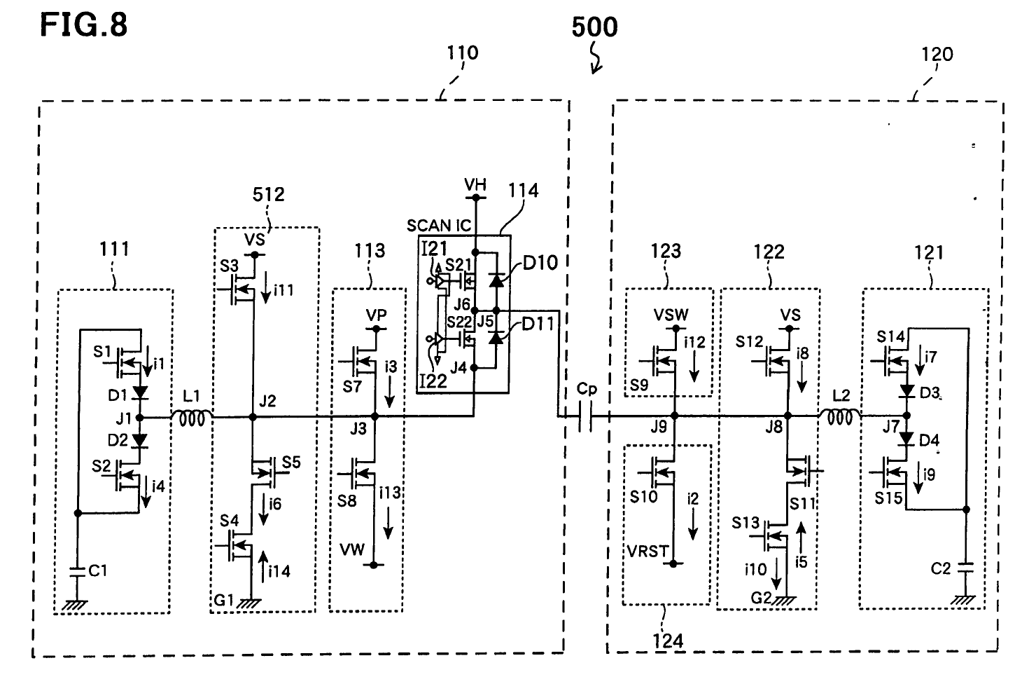

FIG. 8 is a circuit diagram of a circuit 500 for driving a plasma display panel (PDP) in accordance with the fifth embodiment of the present invention.

The circuit 500 in accordance with the fifth embodiment is structurally different from the circuit 100 in accordance with the first embodiment only in the later-mentioned difference. Hence, parts or elements that correspond to the circuit 100 have been provided with the same reference numerals, and operate in the same manner as corresponding parts or elements in the first embodiment, unless explicitly explained hereinbelow.

As illustrated in FIG. 8, the circuit 500 in accordance with the fifth embodiment is structurally different from the circuit 100 in accordance with the first embodiment only in including a sustaining-clamp circuit 512 in place of the sustaining-clamp circuit 112.

The sustaining-clamp circuit 512 in the circuit 500 in accordance with the fifth embodiment is designed not to include the sixth transistor switch S6 in comparison with the sustaining-clamp circuit 112 in the circuit 100 in accordance with the first embodiment. Hence, the second junction J2 is electrically directly connected to the third junction J3.

The power-source terminal VP in the circuit 500 has a voltage equal to or lower than a voltage of the power-source terminal VS, and accordingly, the circuit 500 is not necessary to include the sixth transistor switch S6.

The circuit 500 in accordance with the fifth embodiment has the same structure as that of the circuit 100 in accordance with the first embodiment except not including the sixth transistor switch S6. The circuit 500 in accordance with the fifth embodiment provides the same advantages as those provided by the circuit 100 in accordance with the first embodiment.

[Sixth Embodiment]

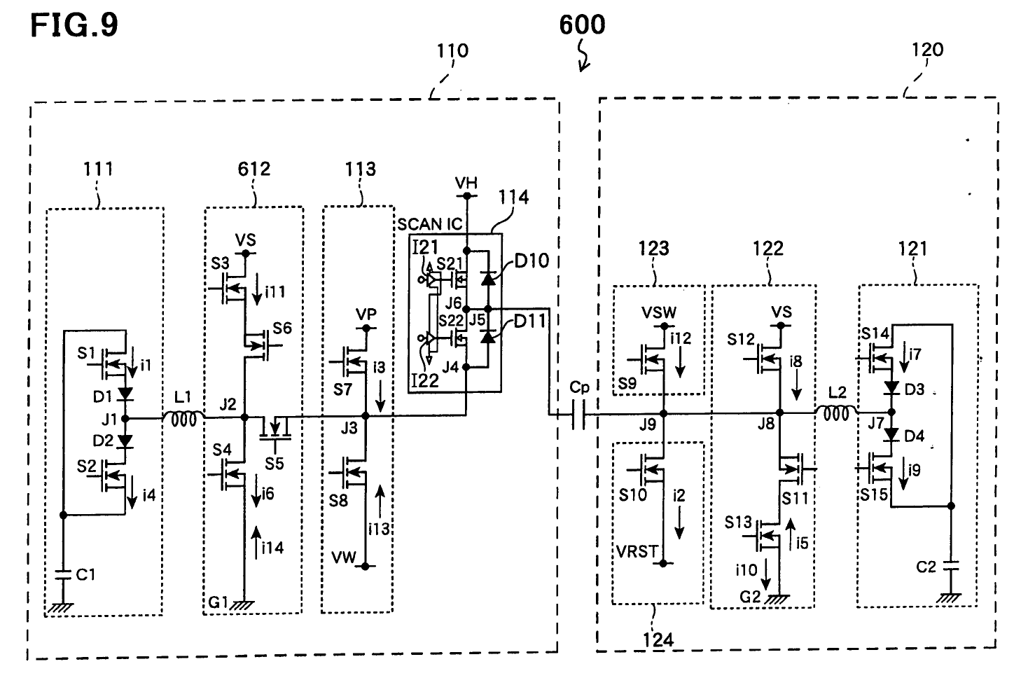

FIG. 9 is a circuit diagram of a circuit 600 for driving a plasma display panel (PDP) in accordance with the sixth embodiment of the present invention.

The circuit 600 in accordance with the sixth embodiment is structurally different from the circuit 100 in accordance with the first embodiment only in the later-mentioned difference. Hence, parts or elements that correspond to the circuit 100 have been provided with the same reference numerals, and operate in the same manner as corresponding parts or elements in the first embodiment, unless explicitly explained hereinbelow.

As illustrated in FIG. 9, the circuit 600 in accordance with the sixth embodiment is structurally different from the circuit 100 in accordance with the first embodiment only in including a sustaining-clamp circuit 612 in place of the sustaining-clamp circuit 112.

The sustaining-clamp circuit 612 in the circuit 600 in accordance with the sixth embodiment is designed to include the sixth transistor switch S6 having a source terminal electrically connected to a source terminal of the third transistor switch S3 without through the second junction J2, and a drain terminal electrically connected to the second junction J2.

The sustaining-clamp circuit 612 is designed to further include the fourth transistor switch S4 having a drain terminal electrically connected to the second junction J2 without through the fifth transistor switch S5.

The sustaining-clamp circuit 612 is designed to further include the fifth transistor switch S5 having a drain terminal electrically connected to the second junction J2, and a source terminal electrically connected to the third junction J3.

In the circuit 600 in accordance with the sixth embodiment, the sixth transistor switch S6 acting as a second current cut-off device is positioned in the sustaining-clamp circuit 612 in a current path other than a current path through which the currents i6, i1 and i4 run when the scanning electrode is electrically connected to the ground terminal G1, when the collection circuit 111 applies a voltage to the scanning electrode, or when the collection circuit 111 collects a voltage from the scanning electrode.

Thus, in the circuit 600 in accordance with the sixth embodiment, the currents i6, i1 and i4 do not run through the sixth transistor switch S6, making it possible to further reduce power loss in comparison with the circuit 100 in accordance with the first embodiment.

However, the fifth transistor switch S5 in the circuit 600 is positioned similarly to the fifth transistor switch S5 in the conventional circuit 1000 illustrated in FIG. 1. The position of the fifth transistor switch S5 in the circuit 600 causes power loss slightly greater than that of the first embodiment.

The circuit 600 for driving a plasma display panel, includes the scanning-electrode driving circuit 110 for applying a drive voltage to a scanning electrode of the plasma display panel Cp. The scanning-electrode driving circuit 110 includes the sustaining-clamp circuit 612 for applying a sustaining-discharge pulse to the scanning electrode, and the reset circuit 113 for applying a reset pulse to the scanning electrode. The first sustaining-clamp circuit 612 includes the power-source terminal VS, the third transistor switch S3 acting as a first switching device through which the power-source terminal VS can be electrically connected to the scanning electrode, and the ground terminal G1 having a ground voltage. The reset circuit 113 includes-the power-source terminal VP having a voltage higher than a voltage of the power-source terminal VS, and the seventh transistor switch S7 through which the power-source terminal VP can be electrically connected to the scanning electrode. The first sustaining-clamp circuit 612 includes the sixth transistor switch S6 acting as a second current cut-off device which prevents a current from running to the power-source terminal VS from the power-source terminal VP. The sixth transistor switch S6 is positioned in the sustaining-clamp circuit 612 in a current path other than a current path through which a current runs when the scanning electrode is electrically connected to the ground terminal G1.

Thus, the current i6 does not run through the sixth transistor switch S6, making it possible to reduce power loss caused by a current running through the sixth transistor switch S6.

[Seventh Embodiment]

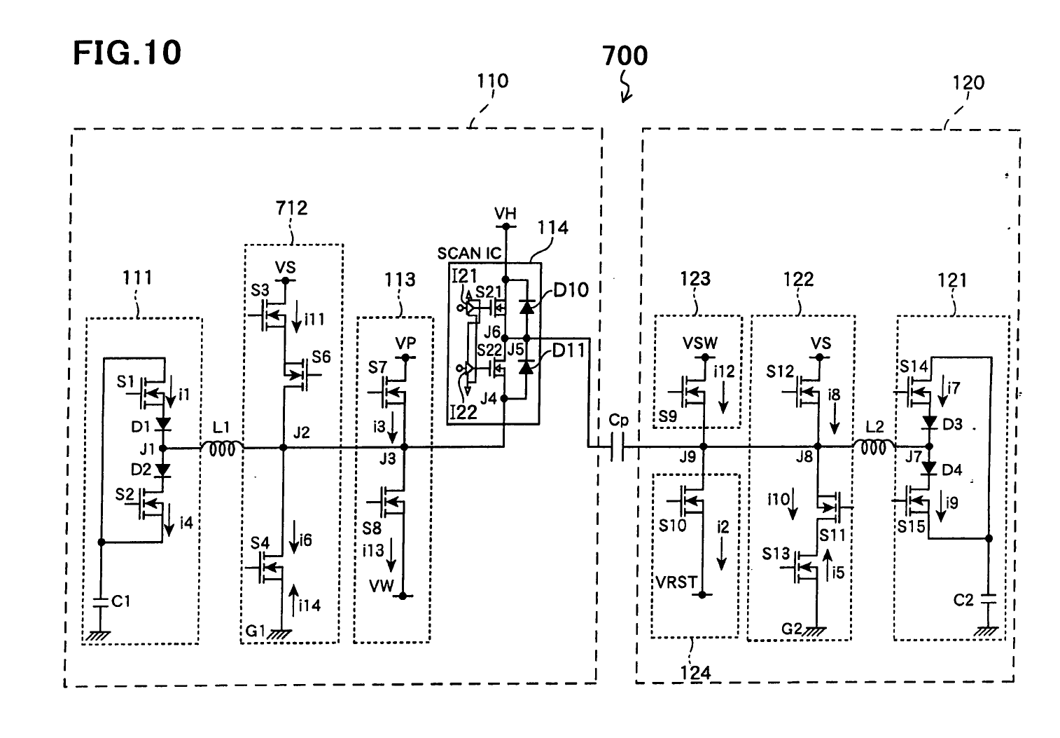

FIG. 10 is a circuit diagram of a circuit 700 for driving a plasma display panel (PDP) in accordance with the seventh embodiment of the present invention.

The circuit 700 in accordance with the seventh embodiment is structurally different from the circuit 200 in accordance with the second embodiment only in the later-mentioned difference. Hence, parts or elements that correspond to the circuit 200 have been provided with the same reference numerals, and operate in the same manner as corresponding parts or elements in the first embodiment, unless explicitly explained hereinbelow.

As illustrated in FIG. 10, the circuit 700 in accordance with the seventh embodiment is structurally different from the circuit 200 in accordance with the second embodiment only in including a sustaining-clamp circuit 712 in place of the sustaining-clamp circuit 212.

The sustaining-clamp circuit 712 in the circuit 700 in accordance with the seventh embodiment is designed not to include the fifth transistor switch S5 in comparison with the sustaining-clamp circuit 212 the circuit 200 in accordance with the second embodiment.

Hence, the fourth transistor switch S4 in the sustaining-clamp circuit 712 has a drain terminal electrically directly connected to the second junction J2.

In the circuit 700 in accordance with the seventh embodiment, the power-source terminal VW has a voltage equal to or higher than a voltage of the ground terminal G1, and accordingly, the circuit 700 is not necessary to include the fifth transistor switch S5.

The circuit 700 for driving a plasma display panel, includes the scanning-electrode driving circuit 110 for applying a drive voltage to a scanning electrode of the plasma display panel Cp. The scanning-electrode driving circuit 110 includes the sustaining-clamp circuit 712 for applying a sustaining-discharge pulse to the scanning electrode, and the reset circuit 113 for applying a reset pulse to the scanning electrode. The first sustaining-clamp circuit 712 includes the power-source terminal VS, the third transistor switch S3 acting as a first switching device through which the power-source terminal VS can be electrically connected to the scanning electrode, and the ground terminal G1 having a ground voltage. The reset circuit 113 includes the power-source terminal VP having a voltage higher than a voltage of the power-source terminal VS, and the seventh transistor switch S7 through which the power-source terminal VP can be electrically connected to the scanning electrode. The first sustaining-clamp circuit 712 includes the sixth transistor switch S6 acting as a second current cut-off device which prevents a current from running to the power-source terminal VS from the power-source terminal VP. The sixth transistor switch S6 is positioned in the sustaining-clamp circuit 712 in a current path other than a current path through which a current runs when the scanning electrode is electrically connected to the ground terminal G1.

Thus, the current i6 does not run through the sixth transistor switch S6, making it possible to reduce power loss caused by a current running through the sixth transistor switch S6.

[Eighth Embodiment]

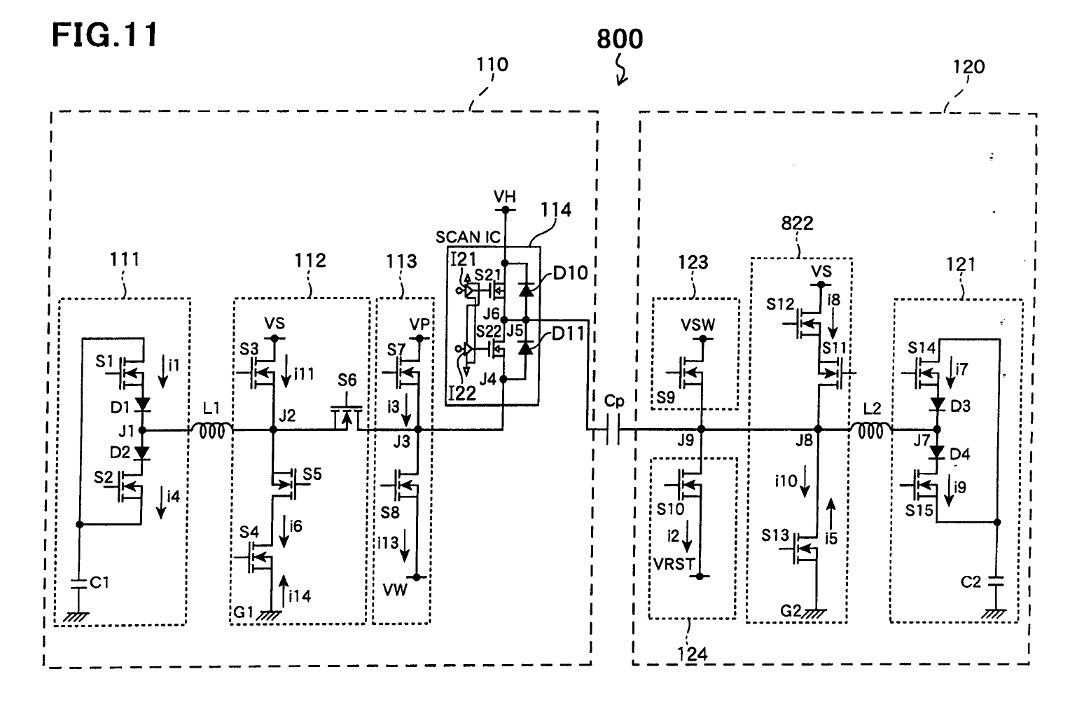

FIG. 11 is a circuit diagram of a circuit 800 for driving a plasma display panel (PDP) in accordance with the eighth embodiment of the present invention.

The circuit 800 in accordance with the eighth embodiment is structurally different from the circuit 100 in accordance with the first embodiment only in the later-mentioned difference. Hence, parts or elements that correspond to the circuit 100 have been provided with the same reference numerals, and operate in the same manner as corresponding parts or elements in the first embodiment, unless explicitly explained hereinbelow.

As illustrated in FIG. 11, the circuit 800 in accordance with the eighth embodiment is structurally different from the circuit 200 in accordance with the second embodiment only in including a sustaining-clamp circuit 822 in place of the sustaining-clamp circuit 122.

In the circuit 800 in accordance with the eighth embodiment, the eleventh transistor switch S11 in the sustaining-clamp circuit 822 is positioned between the eighth junction J8 and the twelfth transistor switch S12.

Specifically, the twelfth transistor switch S12 has a source terminal electrically connected to a source terminal of the eleventh transistor switch S11, and the eleventh transistor switch S11 has a drain terminal electrically connected to the eighth junction J8.

The thirteenth transistor switch S13 has a drain terminal electrically connected to the eighth junction J8.

In the circuit 800, the eleventh transistor switch S11 acting as a third current cut-off device prevents a current from running to the power-source terminal VS from the power-source terminal VSW.

The eleventh transistor switch S11 is positioned in the sustaining-clamp circuit 822 in a current path other than a current path through which a current runs when the common -electrode is electrically connected to the ground terminal G2.

The Y-electrode driving circuit 110 in the circuit 800 in accordance with the eighth embodiment is designed to have the same structure as that of the Y-electrode driving circuit 110 in the circuit 100 in accordance with the first embodiment. It should be noted that the Y-electrode driving circuit 110 in the circuit 800 in accordance with the eighth embodiment may be designed to have the same structure as that of the Y-electrode driving circuit 110 in any one of the second to seventh embodiment.

The circuit 800 includes the X-electrode driving circuit 120 for applying a drive voltage to a common electrode in the plasma display panel, the X-electrode driving circuit 120 including the sustaining-clamp circuit 822 for applying a sustaining-discharge pulse to the common electrode, and the sub-voltage applying circuit 123 for applying a sub-scanning-voltage to the common electrode. The sustaining-clamp circuit 822 includes the power-source terminal VS having a voltage higher than a ground voltage, the twelfth transistor switch S12 through which the power-source terminal VS can be electrically connected to the common electrode, the ground terminal G2 having a ground voltage, and the thirteenth transistor switch S13 through which the ground terminal G2 can be electrically connected to the common electrode. The sub-voltage applying circuit 123 includes the power-source terminal VSW having a voltage higher than a voltage of the power-source terminal VS, and the ninth transistor switch S9 through which the power-source terminal VSW can be electrically connected to the common electrode. The second sustaining-clamp circuit 822 includes the eleventh transistor switch S11 acting as a third current cut-off device which prevents a current from running to the power-source terminal VS from the power-source terminal VSW. The eleventh transistor switch S11 is positioned in the sustaining-clamp circuit 822 in a current path other than a current path through which a current i10 runs when the common electrode is electrically, connected to the ground terminal G2.

Thus, the current i10 does not run through the eleventh transistor switch S11, making it possible to reduce power loss caused by a current running through the eleventh transistor switch S11.

In the above-mentioned embodiments, a third current cut-off device is comprised of the eleventh transistor switch S11. A third current cut-off device may be comprised of a diode in place of the eleventh transistor switch S11.

In the above-mentioned embodiments except the third embodiment, a second current cut-off device is comprised of the sixth transistor switch S6. A second current cut-off device may be comprised of a diode in place of the sixth transistor switch S6.

In the above-mentioned embodiments except the fourth embodiment, a first current cut-off device is comprised of the fifth transistor switch S5. A first current cut-off device may be comprised of a diode in place of the fifth transistor switch S5.

In the above-mentioned embodiments, the first to seventeenth transistor switches S1 to S15, S21 and S22 are comprised of a n-type MOSFET. They may be comprised of other transistors than a n-type MOSFET. As an alternative, switches other than a transistor switch may be used in place of the first to seventeenth transistor switches S1 to S15, S21 and S22.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2005-233983 filed on Aug. 12, 2005 including specification, claims, drawings and summary is incorporated herein by reference in its entirety.

What is claimed is:

1. A circuit for driving a plasma display panel, including a scanning-electrode driving circuit for applying a drive voltage to a scanning electrode in said plasma display panel,
said scanning-electrode driving circuit including a first sustaining-clamp circuit for applying a sustaining-discharge pulse to said scanning electrode, and a reset circuit for applying a reset pulse to said scanning electrode,
said first sustaining-clamp circuit including a first power-source terminal having a voltage higher than a ground voltage, a first switching device through which said first power-source terminal can be electrically connected to said scanning electrode, a first ground terminal having a ground voltage, and a second switching device through which said first ground terminal can be electrically connected to said scanning electrode,
said reset circuit including a second power-source terminal having a voltage lower than said ground voltage, and a third switching device through which said second power-source terminal can be electrically connected to said scanning electrode,
said first sustaining-clamp circuit including a first current cut-off device which prevents a current from running to said second power-source terminal from said first ground terminal,
said first current cut-off device being positioned in said first sustaining-clamp circuit in a current path other than a current path through which a current runs when a voltage is applied to said scanning electrode through said first power-source terminal.

2. The circuit as set forth in claim 1, wherein said first current cut-off device comprises a switching device.

3. The circuit as set forth in claim 1, wherein said first current cut-off device comprises a diode.

4. The circuit as set forth in claim 1, wherein said scanning-electrode driving circuit further includes a first collection circuit which applies a voltage to said scanning electrode and collects a voltage from said scanning electrode,
wherein said first current cut-off device is positioned in said first sustaining-clamp circuit in a current path other than a current path through which a current runs when said first collection circuit applies a voltage to said scanning electrode, or when said first collection circuit collects a voltage from said scanning electrode.

5. The circuit as set forth in claim 1, wherein said reset circuit includes a third power-source terminal having a voltage higher than a voltage of said first power-source terminal, and a fourth switching device through which said third power-source terminal can be electrically connected to said scanning electrode,
said first sustaining-clamp circuit including a second current cut-off device which prevents a current from running to said first power-source terminal from said third power-source terminal,
said second current cut-off device being positioned in said first sustaining-clamp circuit in a current path other than a current path through which a current runs when said scanning electrode is electrically connected to said first power-source terminal.

6. The circuit as set forth in claim 1, wherein said reset circuit includes a third power-source terminal having a voltage higher than a voltage of said first power-source terminal, and a fourth switching device through which said third power-source terminal can be electrically connected to said scanning electrode,
said first sustaining-clamp circuit including a second current cut-off device which prevents a current from running to said first power-source terminal from said third power-source terminal,
said second current cut-off device being positioned in said first sustaining-clamp circuit in a current path other than a current path through which a current runs when said first collection circuit applies a voltage to said scanning electrode, when said first collection circuit collects a voltage from said scanning electrode, or when said scanning electrode is electrically connected to said first power-source terminal.

7. The circuit as set forth in claim 5, wherein said second current cut-off device comprises a switching device.

8. The circuit as set forth in claim 5, wherein said second current cut-off device comprises a diode.

9. The circuit as set forth in claim 6, wherein said second current cut-off device comprises a switching device.

10. The circuit as set forth in claim 6, wherein said second current cut-off device comprises a diode.

11. A circuit for driving a plasma display panel, including a scanning-electrode driving circuit for applying a drive voltage to a scanning electrode in said plasma display panel,
said scanning-electrode driving circuit including a first sustaining-clamp circuit for applying a sustaining-discharge pulse to said scanning electrode, and a reset circuit for applying a reset pulse to said scanning electrode,
said first sustaining-clamp circuit including a first power-source terminal, a first switching device through which said first power-source terminal can be electrically connected to said scanning. electrode, and a first ground terminal having a ground voltage,
said reset circuit including a third power-source terminal having a voltage higher than a voltage of said first power-source terminal, and a fourth switching device through which said third power-source terminal can be electrically connected to said scanning electrode,
said first sustaining-clamp circuit including a second current cut-off device which prevents a current from running to said first power-source terminal from said third power-source terminal,
said second current cut-off device being positioned in said first sustaining-clamp circuit in a current path other than a current path through which a current runs when said scanning electrode is electrically connected to said first ground terminal.

12. The circuit as set forth in claim 11, wherein said scanning-electrode driving circuit further includes a first collection circuit which applies a voltage to said scanning electrode and collects a voltage from said scanning electrode,
wherein said second current cut-off device is positioned in said first sustaining-clamp circuit in a current path other than a current path through which a current runs when said first collection circuit applies a voltage to said scanning electrode, or when said first collection circuit collects a voltage from said scanning electrode.

13. The circuit as set forth in claim 11, wherein said second current cut-off device comprises a switching device.

14. The circuit as set forth in claim 11, wherein said second current cut-off device comprises a diode.

15. A circuit for driving a plasma display panel, including a common-electrode driving circuit for applying a drive voltage to a common electrode in said plasma display panel,
said common-electrode driving circuit including a second sustaining-clamp circuit for applying a sustaining-discharge pulse to said common electrode, and a reset-enhancing circuit which applies a pulse to said common electrode for enhancing resetting performance of said common electrode,
said second sustaining-clamp circuit including a fourth power-source terminal having a voltage higher than a ground voltage, a fifth switching device through which said fourth power-source terminal can be electrically connected to said common electrode, a second ground terminal having a ground voltage, and a sixth switching device through which said second ground terminal can be electrically connected to said common electrode,
said reset-enhancing circuit including a fifth power-source terminal having a voltage lower than a ground voltage, and a seventh switching device through which said fifth power-source terminal can be electrically connected to said common electrode,
said second sustaining-clamp circuit including a third current cut-off device which prevents a current from running to said fifth power-source terminal from said second ground terminal,
said third current cut-off device being positioned in said second sustaining-clamp circuit in a current path other than a current path through which a current runs when a voltage is applied to said common electrode through said fourth power-source terminal.

16. The circuit as set forth in claim 15, wherein said common-electrode driving circuit further includes a second collection circuit which applies a voltage to said common electrode and collects a voltage from said common electrode,
wherein said third current cut-off device is positioned in said first sustaining-clamp circuit in a current path other than a current path through which a current runs when said second collection circuit applies a voltage to said common electrode, or when said second collection circuit collects a voltage from said common electrode.

17. The circuit as set forth in claim 15, wherein said third current cut-off device comprises a switching device.

18. The circuit as set forth in claim 15, wherein said third current cut-off device comprises a diode.

19. A circuit for driving a plasma display panel, including a common-electrode driving circuit for applying a drive voltage to a common electrode in said plasma display panel,
said common-electrode driving circuit including a second sustaining-clamp circuit for applying a sustaining-discharge pulse to said common electrode, and a sub-voltage applying circuit for applying a sub-scanning-voltage to said common electrode,
said second sustaining-clamp circuit including a fourth power-source terminal having a voltage higher than a ground voltage, a fifth switching device through which said fourth power-source terminal can be electrically connected to said common electrode, a second ground terminal having a ground voltage, and a sixth switching device through which said second ground terminal can be electrically connected to said common electrode,
said sub-voltage applying circuit including a fifth power-source terminal having a voltage higher than a voltage of said fourth power-source terminal, and a sixth switching device through which said fifth power-source terminal can be electrically connected to said common electrode,
said second sustaining-clamp circuit including a third current cut-off device which prevents a current from running to said fourth power-source terminal from said fifth power-source terminal,
said third current cut-off device being positioned in said second sustaining-clamp circuit in a current path other than a current path through which a current runs when said common electrode is electrically connected to said second ground terminal.

20. The circuit as set forth in claim 19, wherein said common-electrode driving circuit further includes a second collection circuit which applies a voltage to said common electrode and collects a voltage from said common electrode,
wherein said third current cut-off device is positioned in said first sustaining-clamp circuit in a current path other than a current path through which a current runs when said second collection circuit applies a voltage to said common electrode, or when said second collection circuit collects a voltage from said common electrode.

21. The circuit as set forth in claim 19, wherein said third current cut-off device comprises a switching device.

22. The circuit as set forth in claim 19, wherein said third current cut-off device comprises a diode.
